(19) United States
(12) Patent Application Publication
(10) Pub. No.: US 2011/0145327 A1
(43) Pub. Date: Jun. 16, 2011

(54) SYSTEMS AND METHODS OF CONTEXTUALIZING AND LINKING MEDIA ITEMS

(75) Inventor: WILLIAM S. STEWART, VICTORIA (CA)

(73) Assignee: MOMENT USA, INC., SAN FRANCISCO, CA (US)

(21) Appl. No.: 12/819,820

(22) Filed: Jun. 21, 2010

Related U.S. Application Data
(60) Provisional application No. 61/269,065, filed on Jun. 19, 2009.
(60) Provisional application No. 61/269,064, filed on Jun. 19, 2009.
(60) Provisional application No. 61/269,066, filed on Jun. 19, 2009.
(60) Provisional application No. 61/269,067, filed on Jun. 19, 2009.
(60) Provisional application No. 61/356,850, filed on Jun. 21, 2010.

(30) Foreign Application Priority Data
Jun. 18, 2010 (US) PCT/US10/39177

(51) Int. Cl. G06F 15/16

(52) U.S. Cl. 709/203; 709/217

(57) ABSTRACT

Some aspects relate to systems and methods of tagging to enhance contextualization of media items and ease of use. Tag data structures provide an extensible platform to allow description of a concept from multiple points of view and in multiple contexts, such as locations, activities, and people. Individual application instances using these data structures can each maintain a private store of media items, and can be synchronized with a server. Each application owner can select portions of the private store to share. The server also can maintain canonical hierarchies of tags, such as hierarchies of activities and of places. These canonical hierarchies can be provided to application instances, where private modifications/additions can be made. Owners can offer to share private modifications, which can be accepted or rejected. Displays of media item selections and of clouds of related tags can be formed based on the contextual and relational information contained in the tags and in the canonical hierarchies.

### CROSS-REFERENCE TO RELATED APPLICATIONS

This application claims priority from U.S. Provisional Patent Application No. 61/269,065, filed Jun. 19, 2009, and entitled “Dynamic Desktop Application User Interface”, from U.S. Provisional Patent Application No. 61/269,064, filed Jun. 19, 2009, and entitled “Intelligent Tags”, from U.S. Provisional Patent Application No. 61/269,066, filed Jun. 19, 2009, and entitled “Wallpaper Social Media Sharing”, from U.S. Provisional Patent Application No. 61/269,067, filed Jun. 19, 2009, and entitled “User Interface for Visual Social Network”, from PCT/US10/39177, filed on Jun. 18, 2010, and entitled “Systems and Methods for Dynamic Background User Interface(s)”, and from U.S. Provisional Patent Application No. 61/356,850, filed Jun. 21, 2010, and entitled “Contextual User Interfaces for Display of Media Items”, all of which are hereby incorporated by reference for all purposes herein.

### BACKGROUND

1. Field

Aspects of the following disclosure relate to visual media, and more particularly, to approaches of contextualizing visual media and linking such media to other topics of interest.

2. Related Art

The Internet is filled with information. Some items of information, often visually-oriented items can be tagged with strings of text selected by creators of the items, and those who view the items. Tags provide a mechanism towards allowing users to search for visual content with specified characteristics. Such tagging functionality is, or can be included, in online photography sharing sites, and social networking websites. For example, Facebook is one of many social networks that allow simple tagging. Media sharing sites, such as Youtube, Picassa and other networks also allow text strings to be associated with media items. Such text strings can be used to search for media items associated with them; however, the effectiveness and accuracy of such a search depends largely on a user's ability to guess which images would be tagged with a given text string, as well as other users' fidelity to a given approach of tagging. However, expecting users to adhere to a tagging policy as a whole contradicts a general usage of tagging methodologies, which generally gravitate towards allowing users complete flexibility in tagging. More generally still, further enhancements and improvements to sharing of media items and other information remain desirable.

### BRIEF DESCRIPTION OF THE DRAWINGS

The disclosure that follows refers to the following Figures, in which:

FIG. 1 depicts a diagram of a plurality of client devices operable to communicate with social network sites, and with a server, where the client devices maintain local media item libraries tagged with local tags, organized locally, and where the server has access to a canonical tag hierarchy;

FIG. 2 depicts example components of devices that can be used or modified for use as client and server in the depiction of FIG. 1;

FIG. 3 depicts a functional diagram of a system organization according to an example herein, where inputs from input devices are processed by one or more message hooks, before they are processed by an input handler procedure for a shell process or another application window that has focus to receive inputs;

FIG. 4 depicts a temporal organization of media items, in which at a certain level of abstraction, a given set of events, and an appropriate collage of media items are selected, and where any of the events depicted can be selected for display of a more granular timeframe, and an updated selection of media items;

FIG. 5 depicts a sharing of a media item selection and associated metadata with a recipient, and synchronization of media items and metadata with a server;

FIGS. 6 and 7 depict user interface examples relating to sharing media items and metadata;

FIG. 8 depicts a further user interface example of an invitation to join a network or download an application, where the invitation displays media items, contextual information, and can allow interaction with the media items with a temporal selection capability, in some implementations;

FIG. 9 depicts an example organization of a client device user interface for displaying media items with associated metadata;

FIG. 10 depicts an example user interface generally in accordance with FIG. 10, for display of a media item;

FIG. 11 depicts an example user interface, where interaction capabilities are displayed, as well as techniques for emphasizing relationships between persons, activities, and locations, with an icon or with a media item;

FIGS. 12 and 13 depict an example of point of view metadata selection and display in conjunction with a media item;

FIG. 14 depicts a user interface example where icons representative of tags are arranged around a tag representative of a person;

FIG. 15 depicts an example user interface where point of view context, such as a media item, and location information is displayed about a person depicted in addition to a capability to interact with elements of the world of the person depicted, and in particular musical preferences of the depicted person;

FIG. 16 depicts an example where contact and other information is available for a person represented by a displayed tag;

FIG. 17 depicts a user interface example where a group or entity is a focus of the user interface, causing reselection and rearrangement of the tags to displayed as contextual information;

FIG. 18 depicts a user interface example, wherein a focus is a location, and in which contextual information is selected and arranged accordingly;

FIGS. 19-20 depict examples of user interfaces organized around an activity, and in which contextual information can be selected and displayed accordingly;

FIG. 21 depicts an example association between tag data structures and events, which each can be comprised of a plurality of media items, and synchronization of such associations with a server;

FIG. 22 depicts an example of a tag that may be created for a person's local library, about another person known only socially by the person;

FIG. 23 depicts a contrasting example of a tag that may be created, which includes richer information, such tag can be used to replace of flesh out the tag of FIG. 22 upon synchronization of the different client applications in which those tags exist;

FIG. 24 depicts a synchronization of an application instance with a server, and with another application instance, and updating of metadata elements present in one or more tag data structures;

FIG. 25a depicts an example trust model user interface, in which tags representing persons or groups can be located, in order to control what kinds of information and media items are to be shared with those persons or groups;

FIGS. 25b-d depict how sections of the trust model depicted in FIG. 25a can be used to define groups for sharing of media items and metadata;

FIG. 26 depicts an example where media items can be associated with tags that have permissions controlled by the trust model of FIG. 25a, and in which publishing and new media item intake uses these associations to publish media item selections and to intake new media items and assign appropriate contextual data and permissions;

FIG. 27 depicts an example user interface for new media item intake, and association of media items with tags;

FIGS. 28-29 depicts examples of a user interface for creation of new tags at a local application instance, which can be associated with media items;

FIG. 30 depicts a user interface example of a visual depiction of a hierarchy of tag data structures, which preserve relationship data between those tags;

FIG. 31 depicts a list organization of the tag data structures of FIG. 30;

FIG. 32 depicts how the hierarchy of FIGS. 30 and 31 can be extended with a new tag;

FIG. 33 depicts further extension of the tag hierarchy;

FIG. 34 submitting suggested tags from a local application instance to a server, for potential addition to a canonical (global) tag hierarchy;

FIG. 35 depicts a process of approval or rejection of submitted tags, prior to addition of the tags to the hierarchy;

FIG. 36 depicts a user interface example of an approach to importing contacts, friends, and metadata available through social networking, email, and other contact oriented sources of such information into a local application instance; and

FIGS. 37 and 38 depict approach to suggestions of groupings of people and metadata to be associated with media items, based data collected during usage of a local application instance.

### DETAILED DESCRIPTION

As explained above, a variety of media is available on the Internet, which is not generally searchable by conventional text-based methods; for example, pictures and video are available, but are not natively searchable using typical text-based search engines. Approaches to adding text strings in association with media items, colloquially referred to as tagging, has allowed increased searchability of these items.

This description first provides a functional description of how tagging approaches disclosed herein can be used to provide additional context to display of media items. Thereafter, this description also discloses more specific examples and other more specific implementation details for the usage models for the tagging disclosures herein.

### Introduction

A typical approach to tagging would be to allow any (or any authorized) viewer of an image to provide a free-form textual tag in association with a media item. A search engine can search for which media items have a given free-form tag, or when a given image is displayed, the tags associated with it also can be displayed.

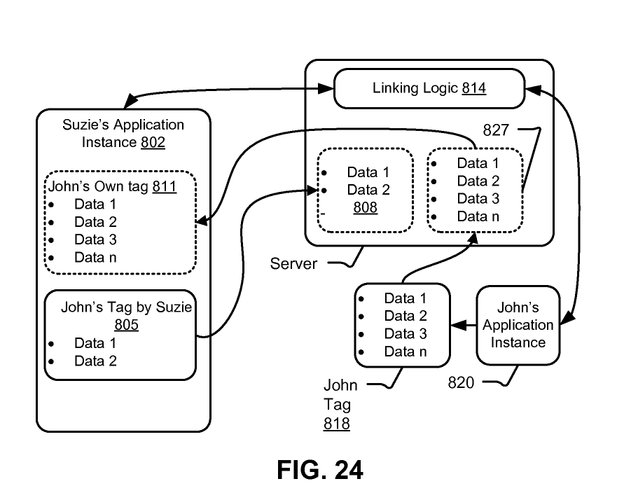

Approaches to improving and extending more rudimentary tagging is disclosed. In some aspects, instead of flat, text-only tags, approaches provide tagging data structures that can link to one another, as well as be associated with media items. Herein, unless the context indicates description of an existing text-only tag, the term “tag” is used to refer to a tag data structure (see, e.g., FIG. 24) that can contain text strings, as well as an extensible number of interconnections with other tag data structures. As such, the term “tag” generally is used herein as a shorter, more convenient term for such a tag data structure with a capability to have a field or fields used to refer to another tag data structure, as well as textual information that allows description of an attribute or characteristic of interest. Examples provided below allow further understanding of tagging data structures. By allowing tags to reference each other, as well as be associated with media, applications can enrich a user's experience with such media, making the media more personal and meaningful. As will become apparent, tags also can contain graphical elements, which can be displayed, and which can be selected, or otherwise interacted with through input devices interfacing with a device driving the display. For convenience, description relating to selecting or otherwise interacting with a graphical representation of a tag is generally referred to as an interaction or selection of the tag, itself.

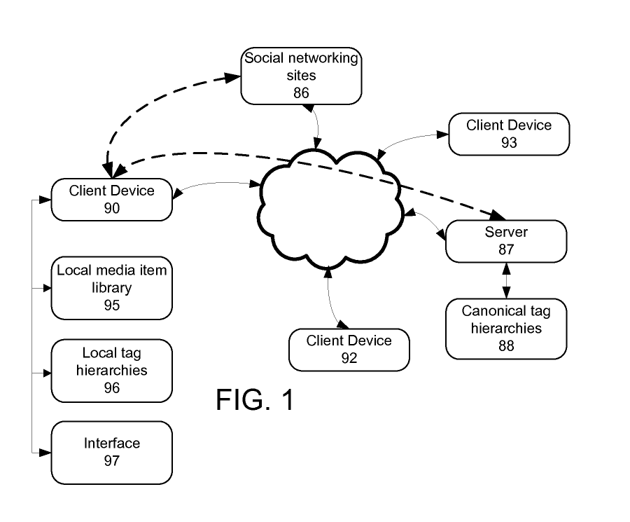

FIG. 1 depicts an arrangement client device 90 that communicates with a local media item library 95 in local tag hierarchy 96 and one or more user interfaces 97. Client device 90 is an example of a number of client devices, which also can be located or otherwise accessible on a network 91; examples of such client devices include client device 92 and client device 93. A variety of social networking sites, collectively identified as social networking sites 86, also can be accessed on or through network 91. A server 87 also is available through or on network 91, and it maintains or otherwise has access to a canonical tag hierarchy 88. The depicted client devices communicate with each other, with social networking sites 86, and with server 87 according to the following disclosures.

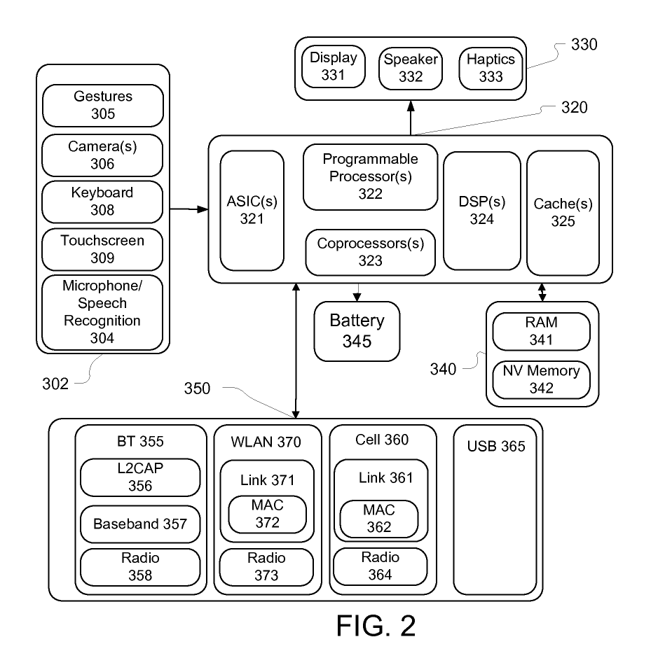

FIG. 2 depicts an example composition of client device 90, portions of such functional composition also can be implemented or otherwise provided at server 87. The depicted device can comprise a plurality of input sources (collectively, input module 302), including gesture recognition 305, input for which can be received through cameras 306, keyboard input 308, touch screen input 309 as well as speech recognition 304. Such input is depicted as being provided to processing module 320, which can comprise one or more programmable processors 322, as well as coprocessors 300-2386 321, digital signal processors 324, as well as one or more cache memories 325. Outputs can be provided through an output module 330, which can comprise a display 331, a speaker 332, and haptics 333. Some implementations of the depicted device can run on battery power 345 either solely or occasionally. Volatile and nonvolatile memories are represented by memory module 340 which can comprise random access memory 341, nonvolatile memory 342, which can be implemented by solid-state memory such as flash memory, phase change memory, disk drives, or another suitable storage medium, such as CD-ROMs DVD ROMs or RAMs, as well as other optical media. Network interface capability is represented by network interface module 350, which can comprise short range wired and wireless communications protocols. Examples of such include Bluetooth 355, which includes components including and L2CAP 356, a baseband 357 in a radio 358. A wireless LAN 370 also is depicted in comprises a link layer 371 iMac 372 and a radio 373, a cellular broadband wireless connection also can be provided 360 which in turn includes a link 361, MAC 362, and a radio 364. An example wired indication protocol includes USB 365. Some or all of these components may or may not be provided in a given device; for example, server 87 typically would not have display 330 14, or a variety of user input mechanisms in user input module 302, nor would it typically have Bluetooth 355, or even broadband wireless interface 360.

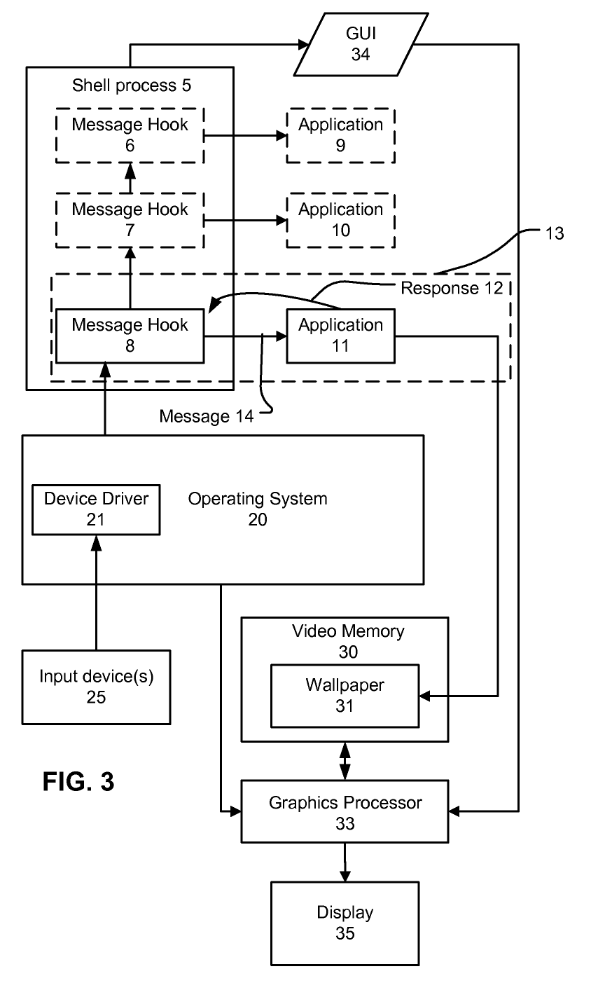

FIG. 3 depicts an example of a communication flow within client device 90, according to an example appropriate in these disclosures. An input device 25, such as a mouse or another input device communicates with a device driver 21, which is depicted as executing within an operating system (20). An output from the operating system comprises messages indicative of user inputs processed by device driver 21. Such messages are received by a message hook 8, which executes within a memory segment for a shell process 5. Message hook 8 filters user inputs, according to a user interface model specified by an application 11. When message hook 8 detects a user inputs, matching the user interface model specified by application 11 message hook 8 generates a message 14, which is sent via interprocess communication to a memory segment in which application 11 executes. Application 11 generates a response message 12, which can be returned to message hook 8. Message hook 8 waits to receive response 12 before determining whether or not to pass the user input message to another message hook 7. If response 12 indicates that application 11 will process the user input in the message, then message hook 8 does not forward or otherwise allow that message to propagate to message hook 7. If no response is received from application 11 (e.g., after a time period) or application 11 indicates that it will not process the input, then message hook 8 can allow that user input to be propagated to message hook 7. Message hook 7 can operate similarly to message hook 8 with an associated application 10. Similarly, a yet further message hook 6 can receive user inputs not processed by application 11 or by application 10. Message hook 6 in turn accesses a user input model for application 9. Shell process 5 maintains GUI 34 for display on a display 35. Information descriptive of GUI 34 is provided to a graphics processor 33. Graphics processor 33 also communicates with a video memory 30 in which a wallpaper background 31 to underlie icons and other elements of GUI 34.

In a more particular example in accordance with a diagram of FIG. 3, operating system 20 can be a Microsoft Windows operating system and shell process 5 can be Microsoft Explorer.exe. Message hook 8 can be set by a global hook process, such that message hook 8 is instantiated to execute within shell process 5 when shell process 5 has focus, as is typically the case when GUI 34 is displayed and no other application window has focus. Further, wallpaper 31 is stored in a reserved segment of the memory 30, so that it can be accessed frequently and quickly.

Thus, FIG. 3 depicts an extension of a typical device operating with an operating system that presents a GUI to a user, where the extension provides a user input model that filters user inputs before those user inputs reach an input handler associated with shell process 5. Such a system can be used for example to demarcate some portions of wallpaper 31, which are to be associated with different applications such as application 11. Message hook 8 can detect when a user interacts with such some portion of wallpaper 31 and create message 14 responsively thereto.

For example, application 11 can install a picture or pictures on wallpaper 31, such that the regions of wallpaper 31 where those pictures exist look different than the remaining portions of wallpaper 31. A user input model can include a definition of a location and extent of those pictures. Message hook 8 can query application 11, when it receives a user input to determine whether application 11 currently has any picture in a location where the user input was received. Message hook 8 further can query a list process maintained within shell process 5 which tracks locations of elements of GUI 34 such as folder icons, program shortcuts, or elements that are shown in GUI 34. If message hook 8 detects that application 11 has a user input model that defines the location of the user input event as a location of interest, and shell process 5 has no GUI element at that location then message hook 8 can redirect that user event to application 11. Responsively, application 11 can begin execution and do any number of things.

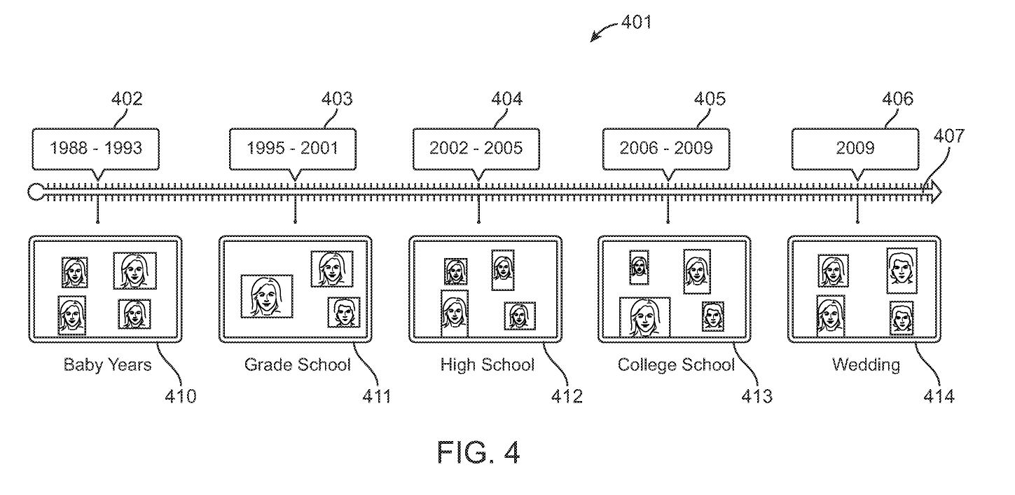

One example application of the system and organization depicted with respect to FIGS. 1, 2, and 3 is disclosed, below beginning with FIG. 4. FIG. 4 depicts that an organization 401 of media items, such as pictures and videos, can be displayed according to temporal groupings of those media items. The temporal groupings can be identified according to a span of years over which the pictures were taken, in addition to information that gives context or definition to what occurred during those years. For example, the first age range 1988-1993 is identified as (402) and a collage of images taken during that time frame 410 can be displayed with a caption “baby years”. Similar date ranges are identified 403, 404, 405, 406; each such date range corresponds to a respective photo or media item collage, 411, 412, 413, and 414. Spine 407 can divide, the display of year ranges from the collage and textual information descriptive of the collages.

For example, an application can search media storage to identify the items and extract metadata such as date and time that those media items were created in order to assemble such an organization as depicted in 401. Such a temporal approach allows a user to drill down into any of the depicted collages, such that the more particular information would be shown, arranged again in temporal order along spine 407. For example, if the user clicked on the collage labeled high school (412), pictures taken during high school would be displayed in more detail, such as pictures taken from freshman year through senior year. Still further particular events that occurred during high school such as prom and homecoming events could be particularly identified. As such, it is to be understood that pictures can be grouped according to events of significance, examples of such events may include holidays, birthday days, vacations, and so on. Thus, FIG. 4 depicts a user interface for accessing content that is available in a user's library and potentially otherwise accessible over network resources. Referring back to FIG. 1, such media items could be sourced from local media item library 95 as well as social networking sites 86, or any of the client devices 92 and 93 as well as server 87.

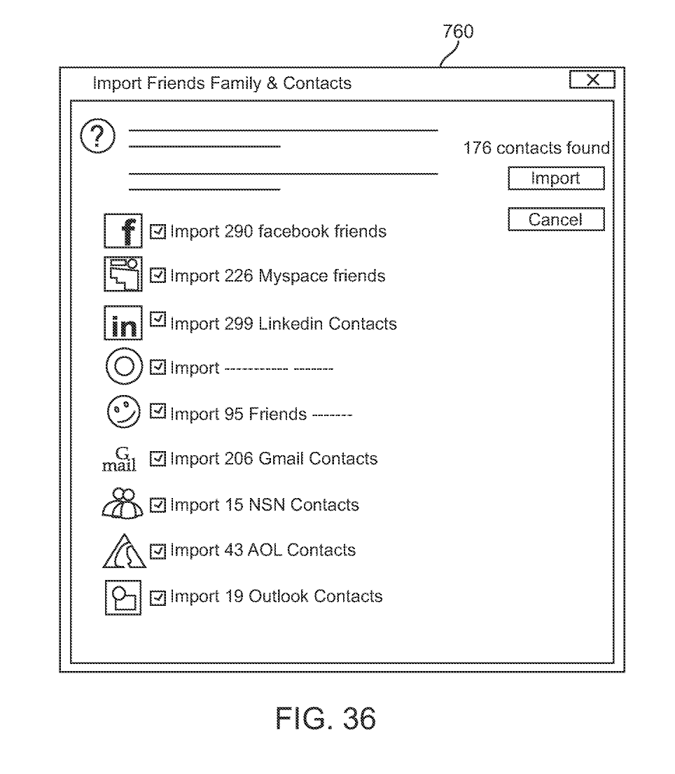

Examples of how client device 90 can access such media items, or otherwise provide media items to be shared to any of those other locations depicted is described below. Contact importing can be accomplished by the user interface depicted in FIG. 36, which depicts an interface 760 for importing identified contacts and connections from a variety of clients and social networking sites. Example results of such importing includes creation of a tag data structure for each such imported contact (unique contact), along with other information accessible to the user performing the importing, such as information available and viewable to the user in profiles established on such social networking sites.

FIG. 5 depicts an aspect of sharing in which a first user device 420 allows a selection 421 of a subset of media items available at device (420) (subset also may include all of the media items available at device 420). A recipient device 427 can, in turn, receive 426 some or all of the media items 421 provided from device 422 server 424. Information 425 represents the recipient of 427 can view such media items in provide commentary or meta data about those items which in turn can be provided back to server 424.

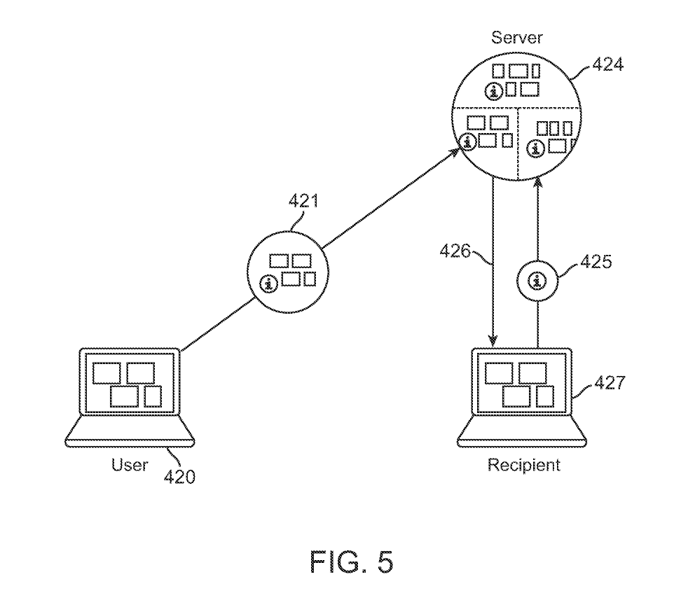

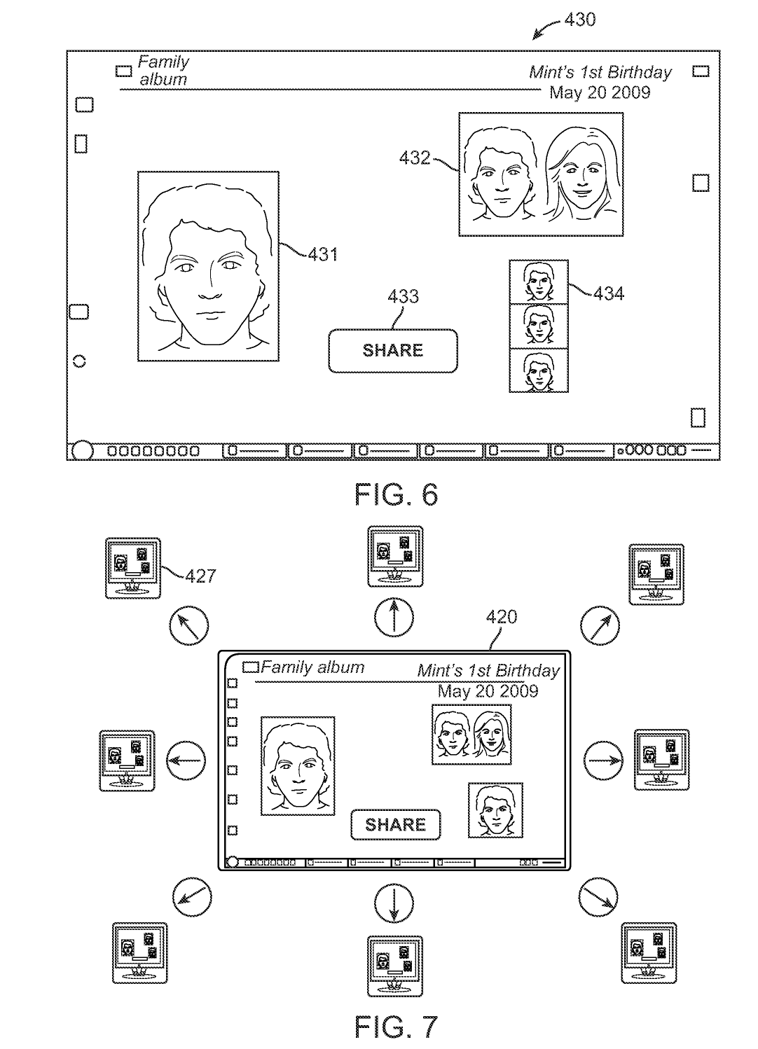

FIG. 6 depicts how a user interface can facilitate sharing of content according to FIG. 5. In particular, a user interface 430 allows arrangement and selection of media items, such as images 431 432 and 434, on a display. A share button 433 allows such images to be shared as a collection with one or more users which can be selected or specified according to examples described herein. FIG. 7 depicts that the arrangement shown in FIG. 6 can be shared peer-to-peer with other devices such as device 427.

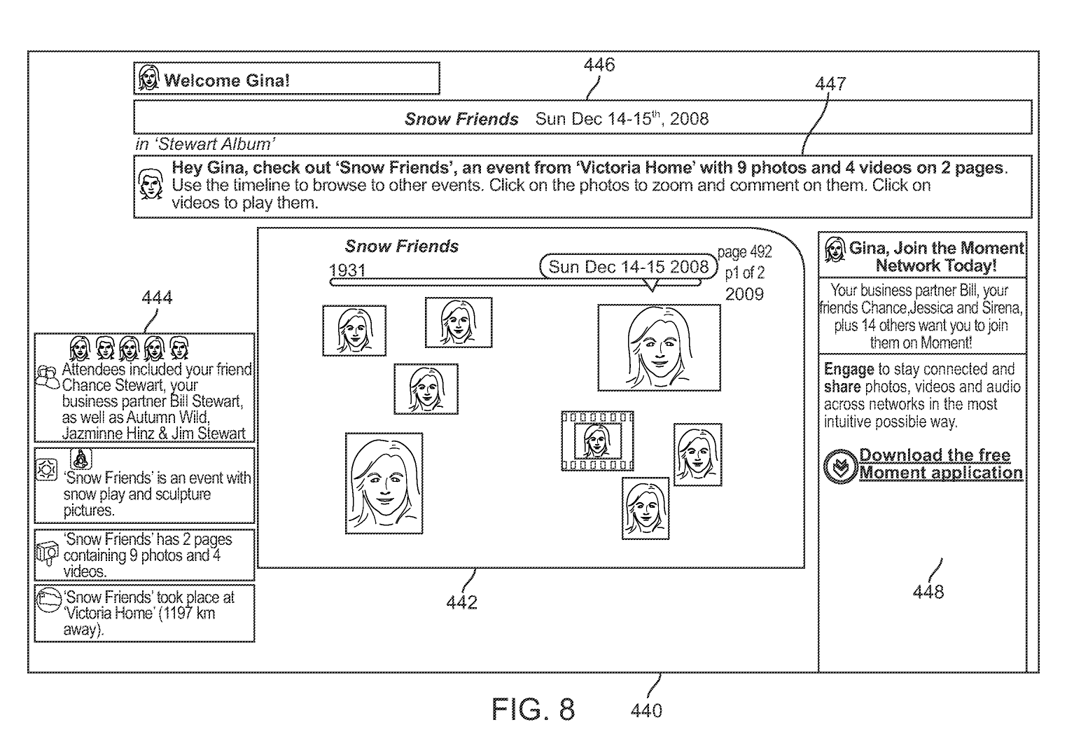

In some aspects, FIG. 6 and FIG. 7 represent how media items can be shared peer-to-peer between multiple devices that have an application installed which allows such media items to be shared. FIG. 8 depicts an example of how an arrangement of media items can be shared or otherwise sent to client device, which does not currently have the application installed, in order to solicit the user of that client device to register and download the application. Aspects of such a solicitation, which are exemplified in FIG. 8 can include a collage of media items 442. The collage of media items can itself contain a temporal bar, which can be moved to allow selection of different media items associated with different times. Additionally, introductory information about a caption and date range relevant to the images displayed can be shown 446, as well as customized message, which can be automatically filled in with information relevant to a date, a place, and a time for the media items depicted 447.

Still further, a personal relevance of the image depicted can be described in another portion of the solicitation message 448; for example, first name or last names of various people who are relevant or otherwise connected to the media items and the recipient can be recited in order to give context to the recipient of the solicitation. Such personal information also can be included with iconized versions of those persons as shown in 444, which depicts that other biographical information about the media items can be displayed therewith.

The screenshot above shows a person who has been invited by an existing user of the application to view content maintained by the application on the web, before the person has joined the service and/or downloaded the client application. This person is presented with a view into the content that recognizes her and her relationships to people both in the photos and on the service more generally. This information can be derived from tagging data structures, as described herein.

As the screenshot shows on the left, the relationship between Gina and some of the people in the photos can be highlighted to make it more personal. On the right, invitation/solicitation to Gina can highlight her relationships to people in these photos as well as her friends who have joined/use the application. This is in contrast to other social networks, where a person is generally not taggable as a definitive contact entry in rich media until they join that network (and usually must be “friends” on that network with the user).

With the present application, anyone can be tagged before they join the service or install the client application, and establish a profile or presence. Such tagging-before-joining does not violate privacy because it does not allow others to communicate with people who haven't opted into the network (joining on web and/or downloading application, which also can create a web presence). For example, a person can tag a concert photo with Bruce Springsteen, but such tagging does not violate Springsteen's privacy because that tagging does not let you communicate with him. However, if you are friends with Bruce and communicate with him, tagging him in content would smooth the process of getting him to use the application, and allow easier content sharing, since he doesn't have to start from scratch to build his online identity.

Being able to tag people who haven't joined yet allows easier tagging of all family members and other relatives more easily. Children, pets and elderly relatives are unlikely to have their own accounts and profiles but are very relevant entities in personal photos and videos. Therefore, the application allows users to tag such people without requiring that they join themselves. Such user-instantiated tag data structures are of local scope to the user's album (the application can support one or more albums; albums can be associated with different users of a device, for example) and not shared (such tag data structures can be synchronized with the server, but are not shared with other users of the application or service). Therefore, a parent could make tag data structures for 3 children simply to allow tagging of their children in their own album(s), and even add details about each child (interests, birth date, preferences) without exposing any information about their existence to the public at large, other users of the application or service, or even users who are connected to the parents, until or unless further actions are taken as described below.

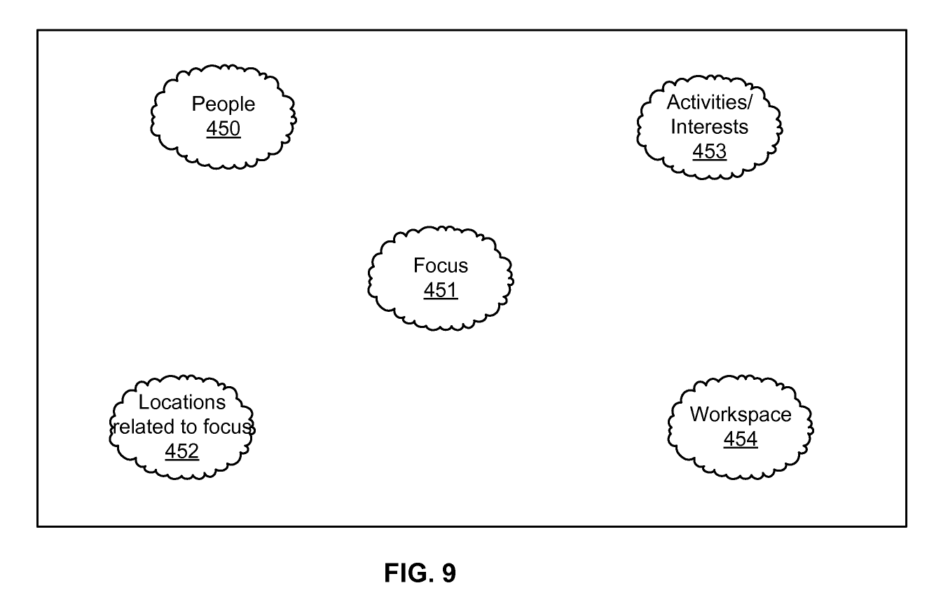

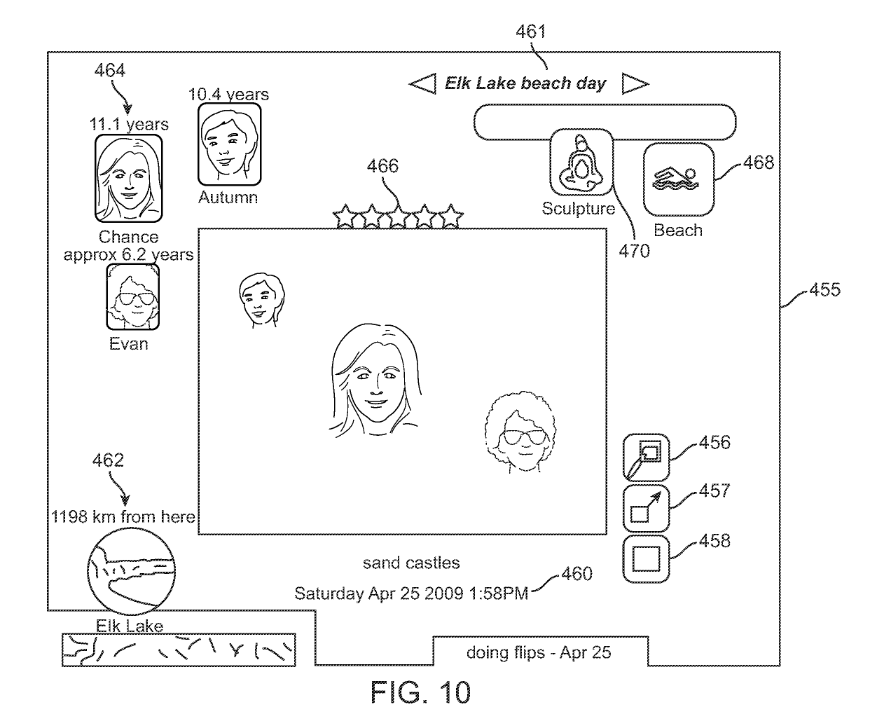

FIG. 9 depicts an exemplary subject matter organization for a display of solicitations according to this disclosure. The display includes a focus media item or tag 451 located at the general center of the display. Different kinds of icons or other media items according to different subject matter are depicted peripherally around focus 451. For example, icons or media items relating to people can be displayed in upper left corner 450. In upper right corner icons or other information relating to activities or interests 453 that are found relevant to focus 451 can be displayed. At a bottom left, locations 452 related to focus 451 can be shown; similarly, other information that may not fit precisely in any of the other categories described above can be shown to lower right-hand portion of the display 454. Particular examples of how such subject matter can be arranged is found in FIGS. 10 through 20.

FIG. 10 depicts an example where an image is displayed as a focus. Tags relating to people appearing or otherwise related to the subject matter of the focus are shown in upper left corner 464. In the lower left corner 462, geographical information about where the focus media item was taken is shown for example, the lower left corner indicates that the media item was taken in Elk Lake and the current location of the viewer of this media item is 1198 km from Elk Lake. Similarly activities including sculpture 470 and beach 468 are located in an upper right-hand corner, as those activities are related to the subject matter of the picture, which is building sand castles at the beach. In other information about the exact date and time that media item was taken can be shown underneath the media item 460. Similarly, icons representing an ability to annotate share or work with the image can be presented as shown by icons respectively 456, 457, and 458.

### User Interface Model

A more particular example is that hovering over a picture for a few seconds can be interpreted by an application displaying the picture as an interest in that photo, to which the application can respond. Left clicking on any tag causes a full cloud of information to be shown about that tag. Click on a person to see who their friends, co-workers, relatives are, what activities they like to do, places they like to go. Clicking on a place shows which people go to that place, what sorts of activities occur there. Clicking on an activity shows related activities, people who do that activity, places that activity has been known to occur, and which are relevant to the viewer.

### Tagging

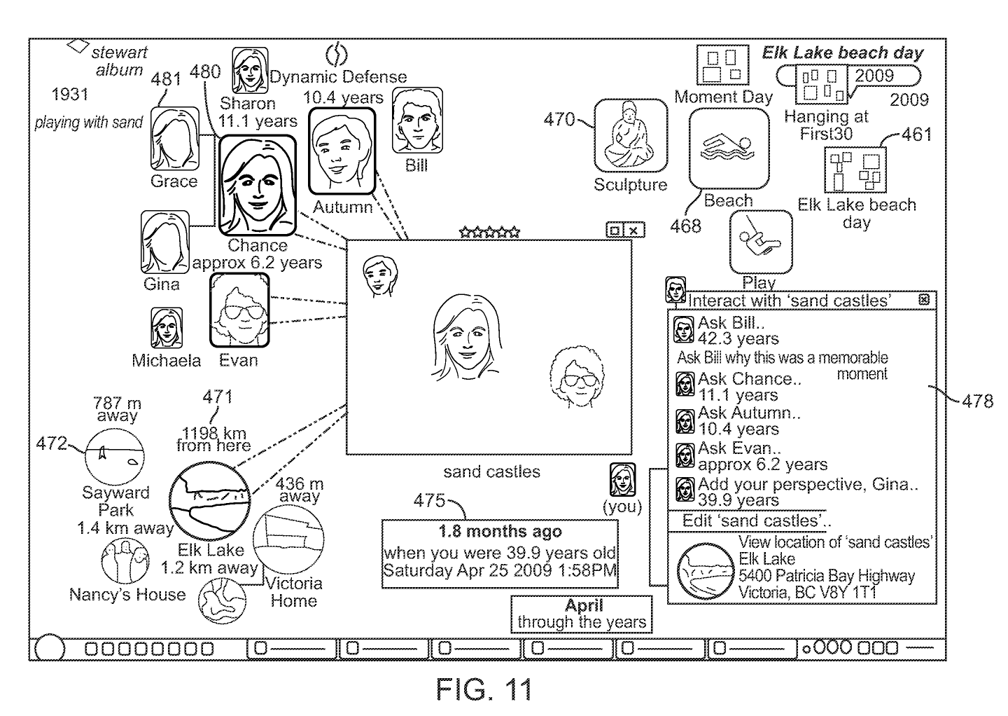

Aspects of tag data structures first are introduced, with respect to FIG. 24, followed by usages of such tag data structures in formulating screens for user interfaces, organizing content and other usages that will become apparent upon reviewing FIGS. 11-23 and the description relating thereto, found below.

Tag data structures disclosed herein are extensible entities that describe people, places, groups/organizations, activities, interests, groups of interests, organization types and other complex entities. A tag data structure can have required attributes, optional attributes and an extensible list of links to other tag data structures. In some implementations, a name and type are required attributes. Depending on a topic to be represented by the tag data structure (e.g., a place, a person, an activity, and so on), other attributes also can be made mandatory, while an open-ended list of optional attributes and links to other tag data structures can be allowed. In some approaches, a tag type indicates the type of concept that the tag represents.

Since these tag data structures can each contain linkage to other information, as well as substantial information themselves, associating a tag data structure to an item of media (photo, video, blog, etc) has much more meaning than associating a simple text string with a media item.

Associating a tag data structure to people, places, events and moments in time establishes a relationship between the concept represented by that tag (e.g., a person, a group of persons in an interest group, an event, a date,) and other concepts by virtue of the interconnectedness of that tag data structure to other tag data structures. By using this interconnectedness, a variety of different kinds of relevant information can be returned as contextual information relating to media items that have been associated with that tag or with related tags.

FIG. 24 depicts an application instance 802, in which Susie has created a tag for John 805. Tag 805 comprises data elements 1 and 2. Server 87 receives a synchronization of John's tag 805, represented by tag 808 at server 87. At a subsequent point in time John downloads and installs the application thus creating John's application instance 820. John creates a tag for himself 818 which comprises data elements one through n. John's application instance 820 causes John's tag 818 to be synchronized with server 87 as represented by tag 827 located at server 87. Linking logic 814 at server 87 controls which information can be shared between Susie's application instance 802 and John's application instance 820. For example, if John and Susie indicate in their respective application instances that they desire to share information about each other, linking logic 814 receives such indications and then allows John's tag 820 to be propagated from server 87 to Susie's application instance 802. Such propagation is represented by John's tag instance 811. FIG. 24 thus represents that tag data structures described herein may contain an extensible number of individual data elements, where each tag can be associated with a particular concept. FIG. 24 particularly illustrates that tags can be associated with people and in an example a local tag can be created for a person within an application instance prior to a time when the person identified by that tag is aware or otherwise has provided any data that can be used in the creation or maintenance of such tag. However, at a latter time, information provided by that person can supplement or in some implementations replace the tag first created locally in that application instance.

Tags represent an entity in a database which itself can have attributes and links to other related tags. For example, a person named “John Smith” can be represented by a tag within a particular user's album book named “My Album”. If this tag ID were “johnS”, a fully qualified global tag ID would be “MyAlbum:johnS”, representing that “johnS” is a tag within the book “MyAlbum”. Where all albums books and all tags are represented in a master database, they can have a globally unique tag ID. This allows any number of albums to have a character with the same tag name without ambiguity. Another album called “SuzieAlbum” could also have a person tagged as “John Smith” with “johnS” as the local tag ID, but the global tag ID would be “SuzieAlbum:johnS”, making it globally unique.

### Trust Model

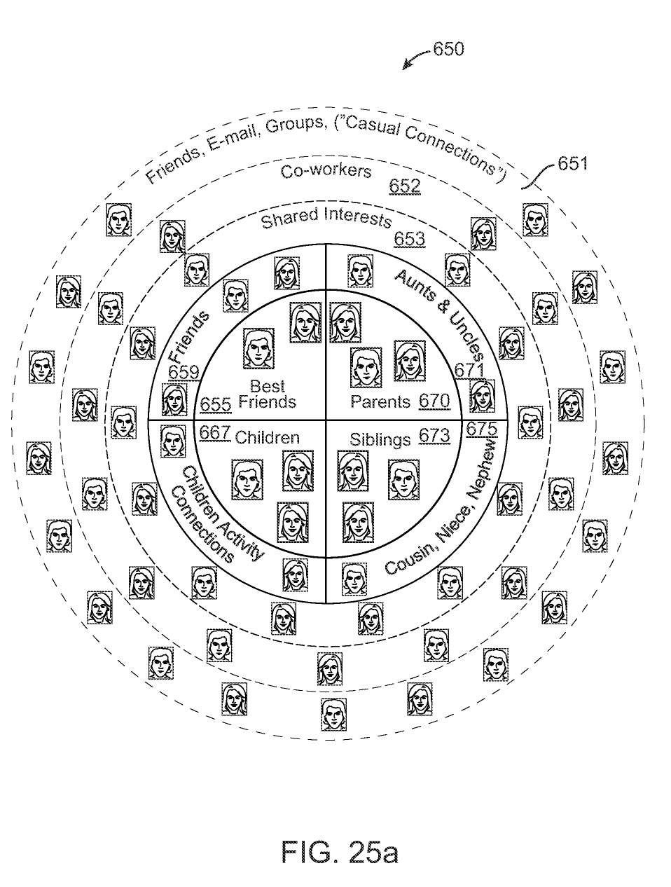

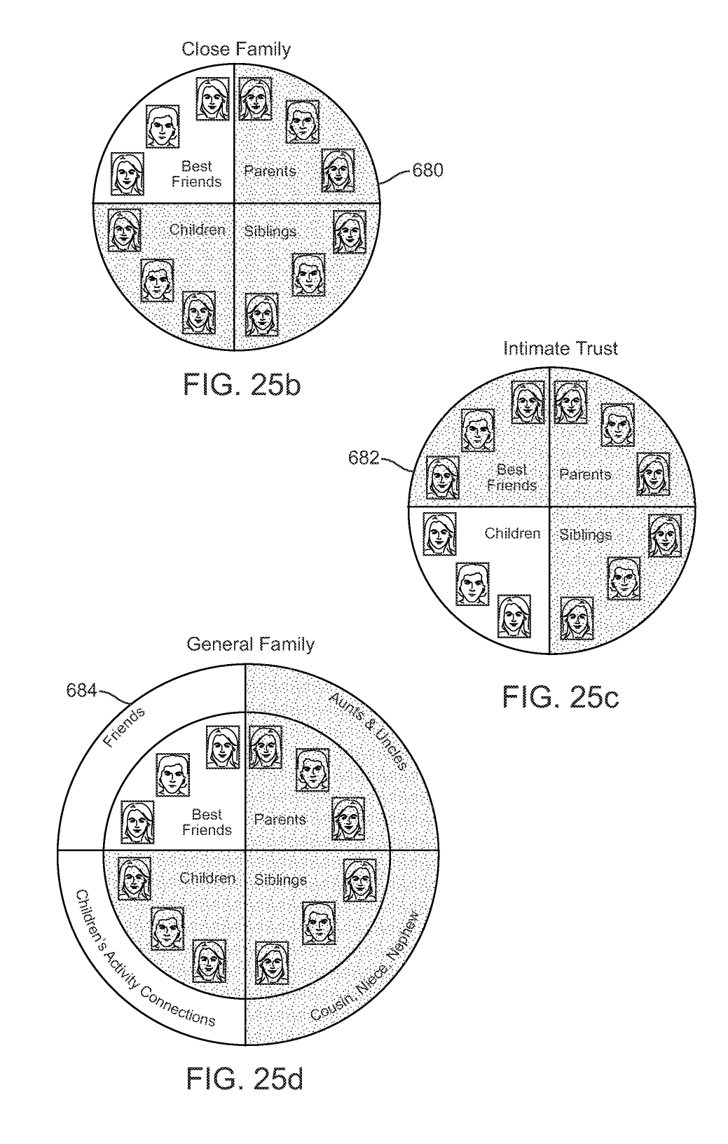

Now turning to FIGS. 25a-d an approach with subtler and more granular trust selection capability is shown. FIG. 25a represents an example where an onion with a number of layers represents a degree of closeness of a tag representative of a particular person or group with the owner of a particular application instance 650 most trusted portion includes categories such as parents 670, siblings 673, children 667, and best friend 655. A ring out from those closest relationships may include Anson uncle 671 cousins, nieces and nephews 675, persons related to children's activities, and friends 659. The depicted example shows that the circle can be subdivided into pie shaped quadrants allowing categorization of people or groups at a particular degree of closeness. For example, referring to FIG. 25b, a group 680 identified as close family can be selected by clicking on the categories of parents, children, and siblings, to the exclusion of best friends 655. By contrast, a group for intimate trust 682 may include best friend 655 as well as parents and siblings but may exclude children. Therefore, the depicted user interface can be shown to allow a visual categorization of a degree of closeness as well as a categorization of what makes a given person close. FIG. 25d shows a still further example where general family 684 is selected to comprise the areas of FIG. 25d devoted to parents, siblings, children, as well as further areas for aunts and uncles, cousins, but excluding children's activity connections, and friends as well as best friends.

A person can be moved to a more or to a less trusted region by dragging and dropping the tag representative of that person. Persons can be located in a default group such as casual connection 651, unless they have been imported or otherwise are related in a way that can be discerned by the local application instance. For example, if the user has imported a number of pictures and tag them with rockclimbing and the tag associated with particular person than the local application instance can infer that that person has a shared interest in rockclimbing and would put that person in a shared interest category 653. Similarly, if the user has tag images with the term work as well as with the tag referring to a person and that person may be located in coworkers area 652.

The user can also define groups among the contacts that make sharing content faster, safer and simpler. For example, if a “Close Family & Friends” group was established, and the user tagged some photos and video clips with their young child, they could be prompted to share such content with only “Close Family and Friends” and not with other contacts they might have such as work colleagues, distant friends or people they friended, but don't know why. Similarly, media tagged as being part of a “Running” activity might be auto-suggested to be shared with the user's “running” group. The user can set up automation rules so that images tagged a certain way are always kept private (not shared) or always shared with certain group(s) without prompting. Such intelligence in the application saves the user from having to manually choose 30 family to see photos of their newborn or risk sharing content with the wrong people. The application watches for behavior cues and asks users if things that they frequently do manually are things they wish to automate. For example, if everything tagged “Running” is always shared with members of the user's “Running Group”, then the application can query the user about whether the user would like this operation to be done automatically in the future.

Each user can set the degree of closeness to each other person they relate to. This closeness is expressed visually and can be used to control how much information is shared outward facing to other users and much of other users' information is surfaced to the user. For example, a user might share personal family photos & most other events with their closest friends and family, but only share pictures from marathons with their running group and very little with people they barely know. On the receiving side, a user would be more interested in immediate popup notifications of content from those very close to them, but would want to be able to turn off or throttle the frequency of notifications when people they barely know add new content.

When new people are added to a person's relationship map, their closeness is initially derived from the relationship. Therefore, when you define a person as your mother (the application can maintain a set of known canonical relationships which are active within the application), she starts with a position in the inner circle and people with no defined relationship to you are initially placed on the outermost circle. However, the user can drag and drop to move people closer or farther away to control specifically how much they share and receive from that person. For example, they might choose to drag an acquaintance closer on the relationship map to share more with them as they get to be good friends or could choose to move a family member further away from the center if they aren't close to them. These changes are likely to reflect changes in the real world closeness the user feels for other people, but can also be used to simply control how much information flows back and forth. A very private person could have nobody in the center circle, with their closest friends and family in the 2^{nd} or 3^{rd} circles if they wish.

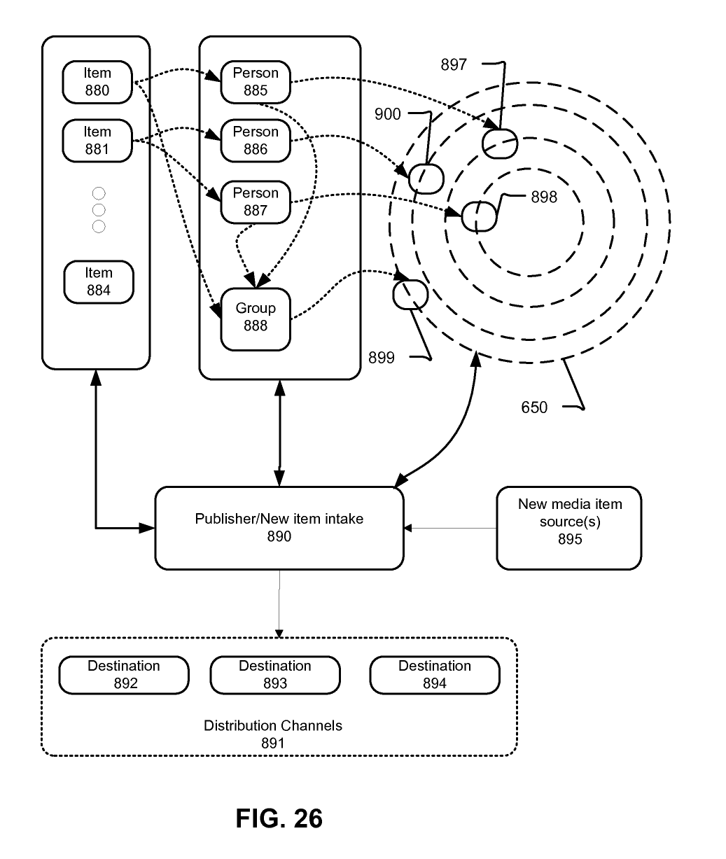

FIG. 26 depicts an example that builds from the trust model disclosures of FIG. 25. FIG. 26 depicts a plurality of media items 880, 881 through 884 (it would be understood that any number of media items can be stored). Tag data structures representative of a number of persons is also available, 885, 886, and 887. An example of a group tag data structure 888 also is depicted. A group tag data structure, such as group tag data structure 888, may reference a plurality of person tags.

A trust model 650 is depicted, and will be explained further below. A publishing and new item intake module 890 is depicted as being coupled to storage of media items, storage of tagged data structures representing persons and to a source of new media items 895, as with trust model 650. Publisher module 890 is also coupled with distribution channels 891, which can comprise a plurality of destinations 892, 893, and 894.

Dashed lines between content items and tags representing persons indicates association of tags to content items. For example, item 880 is associated with person tags 885 and group tag 888. Similarly, items 881 is associated with tag 886 and tag 887.

Person tags and group tags also are associated with different locations within trust model 650, as introduced with respect to FIGS. 25a-d. For example person 885 is located at trust position 897, while person 886 is located at trust position 900, person 887 is located at trust position 898, while group 888 is located at trust position 899. As explained with respect to FIG. 25 iconic representations of the person or any icon representing a group or groups can be depicted visually within trust model 650.

The associations between content items and persons indicate a relevance between each content item and those persons. And further has explained with respect to FIG. 24. Each person tag contains an open ended set of data elements which describe any number of other concepts or entities, such as persons, locations, and activities that are relevant to that person. Each such concept or entity can itself be represented by a tag data structure, which content items can also be associated with. Therefore, using such associations, a web of context can be displayed for a given media item, concept, or entity.

Additionally, a location of each person's tag within trust model 650 can be used to determine whether or not that person should have access to a given item of content. By example, person 885 in person 887 are both associated with group 888, however group 888 is located at the periphery of trust model 650, while person 885 is located closer to the core of trust model 650, while person 887 is located yet closer to the core of trust model 650. Therefore content available to person 885 may not necessarily be available to other members of group 888 and likewise content available to person 887 may not be available to person 885. For example item 881 may be available to person 887, but not to person 885 or to group members of group 888.

From the view of a local application instance, the trust model need not necessarily be invoked. However, in selecting items to be published to a particular destination, the trust model 650 can be used to determine whether a given media item should be made available to certain users or to a particular destination. For example, the invitation depicted in FIG. 8 can be created using a system organized according to that depicted in FIG. 26, where pictures and other media relating to the event shown are associated with contextual information derived from associations between those media items and tag data structures as well as associations between and among those tag data structures and other media items as well as other tag data structures.

### User Interface Examples

FIG. 11 depicts a first example where a picture labeled “sand castles” is displayed as a focus of a user interface. Further user interface aspects relevant to this example are described below. A first aspect relates to a degree of closeness between persons represented by tags in the upper left-hand corner, and the image or other media item presented in the focus. A number of ways can be used to depict an indication of such closeness, including, a comparative size of the tags depicted; for example, the icon labeled Chance is shown bigger than an icon labeled Gina, indicating that the persons represented by the tag Chance (the tags are represented by icons in the sense that an image representative of the tag data structure is shown in the user interface) is closer or more related to the image depicted then the person represented by the tag Gina. Another approach to indicating closeness is a degree of opaqueness or transparency associated with a given icon, which is represented as a contrast between different icons shown in the upper left-hand corner of FIG. 11. For example, the icon for Chance is shown being darker than the icon for Gina. A still further approach to indicating closeness is shown by lead lines numbered 472, where bolder lead lines also can be used to indicate a closer degree of association with the media item presented. In still further examples differentiation between callers also can show different degrees of closeness. For example, an area demarcated between lead lines 472 can be in a color different from a lead line going to Autumn (not separately numbered).

In addition to the display of persons related to a displayed media item, locations related to the subject matter depicted in the media item also can be shown at a lower left. Contextual information about such locations also can be provided. A selection of examples thereof include that a location Saybrook Park 472 is shown as being only 787 m away, while Elk Lake is shown as being 1198 km from a present location where the user currently is. Notably, the examples 471 and 472 illustrate two potential aspects of location information, 472 depicts an example of distance from a location where the media item was taken, while example 471 depicts showing location information between a location were similar activities are conducted and a present location of the viewer. As in the presentation of tags relating to people, a relative importance of different locations can be visually depicted by a selection of any one or more of differentiation in caller differentiation in size of icons depicting different locational tags as well as differences in contrast or degree of transparency among those icons represented. Other aspects of note in a user interface depicted in FIG. 11 include in the upper right-hand corner, a depiction of activities that are related to the focused media item. For example, Beach 468 and sculpture 470 are depicted since the subject matter of the focused item includes sculpting sand castles at the beach. As a further example, the entire collage Elk Lake Beach Day can be depicted as an icon that can be selected 461.

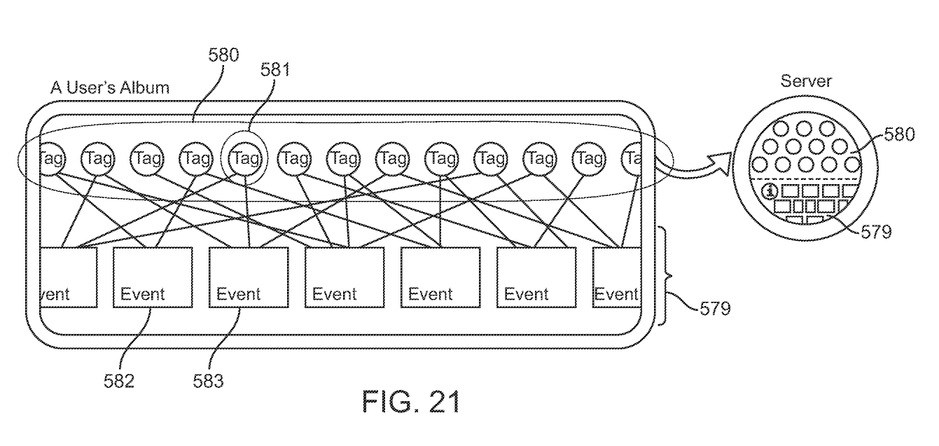

Referring to FIG. 24, a local application instance can identify or otherwise select tags from a large group of tags in all of the categories depicted based on tags that are associated with the media item and focus, or with tags that are in turn associated with related media items or with the tags themselves. For example, FIG. 21 depicts a user's album, which can be located within or can represent a local application instance. In particular, a tag 581 is shown as being associated with a plurality of events 582 and 583, which each may comprise one or more media items. A set of events, or a set of media items is generically identified as 579, while the set of tags available in the system is identified as 580, such set of tags can be replicated to the server as shown by the replication of tags 580 at server. Additionally, the events and the media items categorized within those events also can be replicated.

As such, the tag (icon) for Gina can be selected for display because Chance may have been a person tagged with respect to sand castles while Gina is associated with a number of pictures relating to sculpture, the beach, or locational information depicted, for example. By further example persons such as Gina or Grace can be selected to be shown because they have indicated an interest in the subject matter in their own profiles, and they also have been indicated as being trusted by the viewer of the media item. Further discussion relating to trust is presented below.

Further aspects of the user interface of FIG. 11 allow a selection to interact with the persons relevant to the media item by a pop-up and menu 478 that allows a message to be sent to contact information associated with the depicted persons. Further, locational information also can be presented in such a pop-up menu.

### Relationships Between Tags

As evident from the above discussion relating to the user interface example of FIG. 11, tags can have one or many relationships between each other. Each tag keeps it own list of all relationships to parent, child, sibling items and other types of relationships. For example, a person “John” may have a sibling relationship to “Bob”, but also a 2^{nd} relationship of “tennis partner”. Other entities have similar relationships. Activities such as “Swimming” can have a parent “water sports”, siblings “diving” and “snorkeling”, and child items “competitive swimming”, “fun swimming”. Places and groups can have similar relationships between the same type of tag or with other tag types. For example, a commercial ski hill “Sunshine Village” can link to “Sunshine mountain” as its location, to certain people who work there in an organizational structure and to community groups that patrol the mountain.

A person, John, could tag his hometown, his activities, and type of events his pictures and videos represent. His hometown could link to friends in his social net that are from the same place, to places to visit around his hometown, to popular activities in his hometown. Each tag becomes a strand in interconnected webs of meaning. Others viewing them would see tags describing who, what, where and why of these entities from their subjective viewpoints. For instance, if John and Mary both attend a John Mayer concert—are in each other's social net, as determined by common usage of the application, but aren't aware they took photos at same event—once they publish photos, the application would inform both parties and invite them to share media and comments from the experience. The tags of Mary's media from John's perspective would read as Mary's concert video and vice versa in the subjective viewpoint of each party.

### Context-Aware Relational Entities

A tag represents an entity in a database which itself can have attributes and links to other related tags. For example, other personal information can be optionally associated with MyAlbum:johnS such as nickname, address, phone numbers, email, web sites, links to social networking pages, and details such as favorite books, music, activities, travel locations and other information. The amount of information which can be associated with a tag is open-ended.

His tag can be associated with physical locations (places he lives, works, used to live, etc) and can be associated in relation to other tags in a hierarchy. For example, his tag can link to other tags which represent his parents, siblings, children, friends, acquaintances, spouse and other relationships. Each linkage would define not only a connection to another tag, but also the nature of the relationship. There can be multiple links to the same tag. Therefore, if he teaches piano to his daughter Jane, he can have a link to tag “Jane” representing she is a daughter and another link showing “Jane” is his student.

Following the example, John might be interested in Music, Astronomy, Swimming and Skiing so he might have links to tags for each of those activities as well as links to tags for the swim club he belongs to, the company he works for, and other interests, activities, and locations, such as locations at which the activities are performed.

The activity tags can be from a master taxonomy maintained (such as on a server) for all application users. However, activities can be defined by any user, and retained as a local definition. Also, a user can create linkages between different activities, or between concepts and activities that are not present in the master taxonomy, and keep those linkages private. Also, a user can extend the master taxonomy into more granular and specific areas, if desired. For example, the Astronomy tag would be a part of the master set of tags, but he could add Radio Astronomy as a child tag of Astronomy. Activities exist in a hierarchy similar to people's family relationships.

For example, John's interest in Astronomy would link him to other people who have an interest in Astronomy, both within his social network and globally throughout user base. It would also connect any pictures or videos tagged with Astronomy to other moments within his album and outside his album to other people's moments.

Astronomy would belong to the family group Science with sibling members for other forms of science. Science would in turn be a member of the group Learning. Astronomy could be linked to certain places (ie. where Astronomy was founded, where great discoveries occurred, where the best places currently are in the world for Astronomy) and would provide linkage within John's album to places he has taken Astronomy photos or videos. A concept like Astronomy could also be linked to people such as important people in the history of Astronomy and people who share John's interest in Astronomy.

### Global/Local

Users can use the disclosed tag data structures to store descriptions and interconnectedness of concepts in their personal worlds, in their own way, and yet still link to the wider conceptual world of other users. By way of further explanation, it is common for photo software to allow complete user control in describing one's photos by typing in free-form text tags. However, such strings of text have no inherent meaning and therefore add less value than tags which exist in a taxonomy. For example, if a user tags some photos with the text string “waterskiing” and others with “waterski”, software would be unable to identify a relationship between them or perhaps that either relates to a broader concept of general water sports, so that these tags add little to the available context or ability to connect media items tagged with these tags, unless someone is aware of such tags and a reasonable precise spelling of them or variations thereof.

While such limits do establish a link to an actual person who may have a detailed profile on the system, such an approach also limits who and what can be tagged. However, in the present application, if the person, place, activity, group or other entity does not exist within an existing canonical list or taxonomy, or there is no otherwise pre-existing relationship between that entity and a given user, the user can still create a tag data structure that represents that entity, within that user's own local tag database, with its own local taxonomy, and then use that tag data structure in associations with media items.

For example, even though a user's grandmother or pet may not use the application or web service, the user can create a tag data structure for grandma and another for the pet, and eventually, if grandmother participates in the system, then the information existing in the user's grandmother tag can be shared with grandmother, along with the media items associated with this tag data structure, and vice versa.

By further example, a person can do a specialized activity (such as basejumping) that doesn't currently exist in a canonical activity list. That person can create a tag data structure for “basejumping” and link that tag data structure within a local taxonomy to other tag data structures (which can be populated from the canonical activity list), such as under a tag data structure titled “Extreme sports”. As such, the local taxonomy continues to have a relationship with the global/canonical taxonomy, even while also having the characteristic of being extensible. These local (“private”) tags can be kept private or the user may choose to submit private tags for possible inclusion in the canonical/global list.

For each tag, there is a local data store (part of the local data store for a user's album) plus a server-side copy (part of the server side data store for that album). The tag may also have linkage to other versions of the same entity either in a global tag set or in other user's album. For example, a million users might like Bruce Springsteen and have personal concert pictures with Bruce in them. Since users can tag anyone and anything in their own personal photos and videos, each of those million users can tag Bruce as an entity in their photos. Two such tags might have IDs such as “JohnAlbum:Bruce” and “SuzieAlbum:Bruce”. Each user can create their own Bruce tag, which is independent of the others. However, if the application identifies a likely connection, it can query whether a user's local tag is related to a global tag which his record company maintains. (ie. Is your tag ‘Bruce Springsteen’ the same person as global tag ‘Bruce Springsteen’?).

If the user indicated they are the same tag, any pictures with Bruce now expose links to his discography, concert dates, merchandise, fan sites, etc. If one of those users who tagged Bruce was actually Bruce's mom and Bruce himself had defined her in his relationship map as a trusted relation, then she would get access to his full personal profile, his likes and preferences, etc. while strangers would only have access to any publicly accessible ‘Bruce Springsteen’ information.

For another example, imagine John and Suzie are two people who know each other. Suzie is already using the application and has pictures. She tags John as a person in some of her pictures, even thought he has not actually joined the network and he has not downloaded the software. If she tags him in baseball photos and isn't quite sure his exact age, the ‘John’ tag in her book has only an approx age and only one interest, namely ‘baseball’. At some later time, John himself joins himself and enters much more information into his profile or imports his profile from Facebook. His tag for himself would then be richly detailed with his activities, interests, birth date, preferences, etc. If he sets Suzie as a member of his trusted group who can view his full profile, Suzie would then get a notification that a possible match has been found between John's fully detailed tag for himself and her thinly detailed tag for him. If she confirms that they are a match, then any pictures she ever takes with John in them will then link to his detailed tag for himself, not her isolated and thinly detailed one. As John updates his preferences and interests over time, his trusted friends would automatically have access to his preferences, a click away from any pictures where he is tagged.

If Walter, a friend of Suzie's, also joins and takes pictures of their baseball team, he could tag John in some of his pictures. If Walter is not a part of John's trusted group, his tag representing John would only contain the data he enters himself. He would not get a notification allowing him to link to John's tag for himself unless he becomes friends with John and John then adds him to his trusted group.

### Local and Global Data Store Synchronization

Each tag referred to in a user's album will exist as a database entry in a local data store. This data store is accessible even when users are offline (not connected to the internet). The entire local data store can have an equivalent server side data store which gets sync'd up periodically to the local data store, exchanging changes made from either side. For example, if a user creates an album with a cast of people who appear in pictures, each of those people will have an entry in a local data store which is echoed up to a server side data store for that album. Therefore, even when the user who owns the album is offline, their content and meta-data are still accessible. The user could grant rights to select other users to apply tags to content and modify details about tags. For example, Suzie has a album which has a few pictures tagged with John. She might allow John to choose to have his own, richly nuanced tag for himself be referenced in Suzie's book because they are real-life friends. Once that is done, any changes he makes to his personal profile would be echoed back down to Suzie's local data store copy of his tag. Such echoing would occur as a background process whenever the application is connected to the internet. Therefore, there can be 2-way synchronization of changes between the local and global data stores for each album and the tags contained in those albums.

### Tags as Custom Private Tagsonomy

The tags that a user has when they start using the application can be supplied from the server, but this taxonomy of people, places, groups and subject matter/activities is extensible and customizable by each user. Each user can start with at least one person (themselves) and at least one location (their home) and a hierarchically organized set of activity/subject matter tags maintained on the server. While the set of subject matter/activity tags are organized to facilitate tagging, they likely would be incomplete for a number of users' tagging needs. Therefore, users have the opportunity to add their own tags and establish connections between different tags, which do not exist at the server (in the global store). This allows users who have already tagged content with free-form text tags to pull that content and those tags into the richer tagging model disclosed herein. Users also can extend the taxonomy of tags to encompass more subject matter, more subtlety, and more connectedness to other tags, to reflect their particular areas of interest.

For example, many users would find the tag “bird” sufficient to tag pictures with birds, but someone with special interest might wish to have special tags for each type of birds, flightless birds, marine birds, preparing birds as food, training birds, sales in pet shops, etc.

The extensible tagging system allows users to express the subtlety of their world their own way and still connect with the wider world of other people. Each user's local album has its own client-side set of tags which does not affect other users, is fully editable by the user and is updatable with new additions from the common server set of tags. For example: a user John has “John's Album”. His album can start with a server-provided set of tags, but John can add any tags he wants, including setting up hierarchical relationships between his tags and the pre-existing fixed tags provided by the server. His tags are scoped to his own album, so if he creates a “pool” tag that refers to playing billiards, it has no effect on another user who creates a “pool” tag for playing in a swimming pool. Additionally, in this example, the “pool” tag of John likely would be put into a tag taxonomy under a different portion than a tag relating to water sports or other aquatic activities.

### Extensible Canonical Tagsonomy

A server can host a master set of common tags that may be useful for all users. The taxonomy of tags (tagsonomy) provides users a good base of tags organized hierarchically. This structure not only makes it easier for users to tag their content (since many of the tags they need are provided), but the taxonomy also gives structure for users to place new tags into a logical hierarchy that grows in value as users extend it. Unlike each user's local tags, the server side tags would be vetted before the master tag list can be changed or added to. The process of new tags being added to the master list can occur as follows.

A user is using the application, and gets a copy of the server side tag set; as the user starts tagging their content, he creates new tags for special interests not specifically provided in the master tag list. These new tags only exist within the scope of their personal album. The user submits these (some of) personally-created tags to the server, such as those that the user considers would be generally useful to a broader audience. To submit a local tag, the user would select a tag from their local visual list of tags and select to submit to the server global set, such as from a menu item.

User-submitted tags can contain a suggested location for the tag to exist within the Tagsonomy, such as indicating that the tag is a child of a certain tag, possibly sibling to certain tags, or parent to other tags. Such tags and the proposed positioning can be reviewed, resulting in acceptance or rejection. If accepted, the tag would be added to the master tag list, which can be automatically pushed out both to new users and periodically pushed out to existing users as an update.

### People as Tags

A person can be represented by a particular type of tag that has attributes and linkage to other tags that describe a person, their interests, relations and connections. A person can have connections to many other people and multiple connections to the same person. For example, someone's wife could also be their tennis partner, their co-worker could also be a member of their book club. A person has a range of activities and interests which are described through a series of Activity tags. These Activity tags might initially be based on a user's profile on another social network, typed in by the current viewer (based on their knowledge of the other person), or input by the person in question themselves. However, the application also can track or create metrics to weight the importance of the tags to a given user or a given subset of content. One way the application can determine weighting is by the number of times a tag is applied to pictures that relate to a particular person, or are otherwise known to be of interest to that person.

If a person is tagged in 90 photos skiing and only one with snowboarding, a reasonable inference is that the user is more into skiing. Other metrics also help weight the tags such as frequency of related activities (planning related events like a ski trip, buying related ski gear, adding ski equipment to a wish list, etc). A user can also manually order their own list of interests to indicate which are most important to them. The application can combine explicit information (manually input) and implicit information (based on observations of behavior related to a tag) to weight the tags.

Geographic location tags add to the information about a person. The person can have a live physical location, a home, a workplace, favorite places to do things, a wish list of travel destinations and other geographic places of interest. Contact information including email, phone numbers, instant messenger ids, social network ids, etc can be added to a tag to make them easier to contact through a user interface.

All of a person's vital statistics can be part of the tag, including birth date, death date for deceased individuals, gender, sexual preference, etc. Some of the information can be stored in a fuzzy, less explicit way. For example, a user might know that their friend is about 40, but not know their exact birth date, so the application can allow some date to be stored without being absolutely explicit. Such data can always be redefined to the actual data if the user learns such details later.

One or many pictures of the person's face over time enrich the tag's ability to describe a person. Each face picture can be from different points in time, showing what the person looked like at different ages when cross referenced to the person's birth date. Additional information such as favorite books, music, movies, quotations, goals, medical details and other information add to a nuanced view of a person. Each person described by a tag can include some or all of this information. The minimum would be a first name for a new acquaintance, but this creates the tag which can be added to as long as the user knows the person.

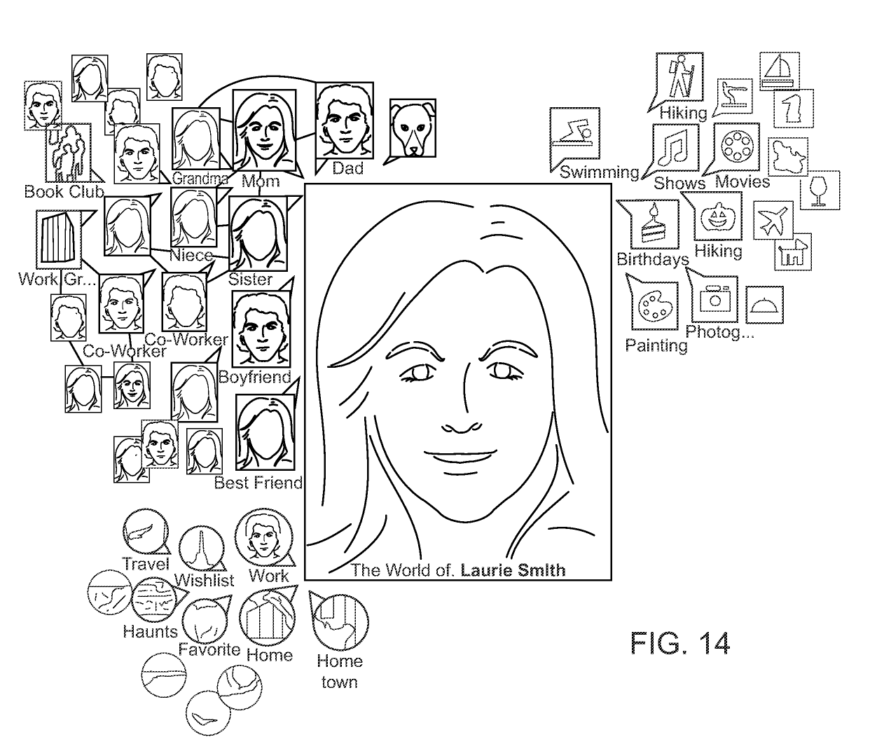

FIG. 14 depicts an example user interface oriented around a person, which can be presented responsive to a click on an icon of a person, present in another displayed user interface (e.g., that of FIG. 8, FIG. 8, and so on). When another item or icon is in focus causes that person's tag to be shifted into focus and the remaining contextual information rearranged according to tag data available to the viewer relating to the person depicted. Activity information depicted as well as locational information depicted.

FIG. 14 suggests that Lori Smith has shared a lot of information with the viewer, such that a reasonably complete set of locations of interest to Lori Smith as well as activities that she likes to engage in are displayed in therefore known to the viewer. However, if Lori Smith had not share such information, a large number of the activities locations and persons presented in FIG. 14 may not be available for presentation to the viewer. This is so even if such information is available in a tag for Lori Smith stored at server 87, so long as Lori Smith has not explicitly indicated that the viewer is to receive such information.

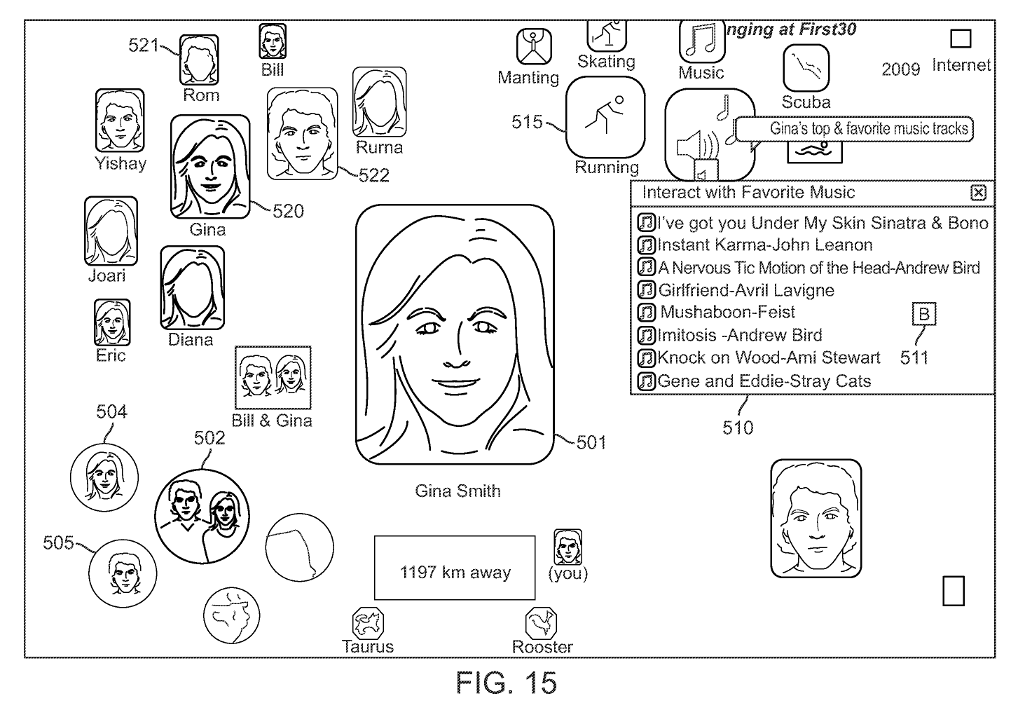

FIG. 15 depicts an example where viewer Bill is viewing the world of Gina Smith, where the tag for Gina Smith 501 is the focus of the user interface (which causes the remainder of the tags presented to be selected and arranged according to the tag information available to Bill about Gina Smith). Examples of information that can be presented include a particular image in which Bill and Gina appear as shown to the left of tag 501. Locational information of relevance can include a location 502 where such a media item was taken. A present location of Gina Smith also can be shown such as underneath tag 501, or with an icon 504 representative of Gina located in an area allocated to locational information. As before, a differential in significance of different persons to the life of Gina Smith can be shown by differentiation among the sizes of tags, transparency or up security of tags color schemes and the like. Examples of such include a larger tag icon 522 compared to a smaller tag icon 521. Such information also can be associated with activity icons, as exemplified by a larger icon for running 515 than skating. The user interface presents an easy capability for the viewer to interact with activity tags presented as being relevant to Gina Smith. For example when the viewer clicks on a music icon, a pop-up window can be presented, which identifies music of interest to Gina Smith. Such information can be gathered from the tag information provided in the tag data structure represented by the tag Gina Smith 501. Such information also can be inferred based on Gina Smith having tag data structures relating to music items or otherwise added contextual information expressing an interest in such music. An icon can be provided 511 that allows a particular music items to be purchased.

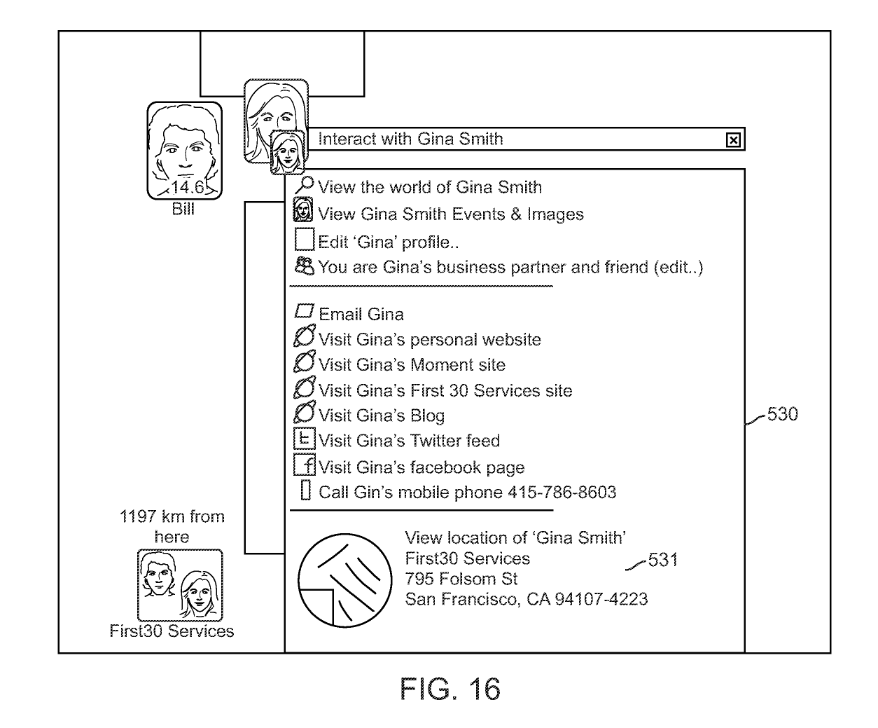

FIG. 16 depicts an example pop-up window 530 that is presented when the viewer interacts with a particular tag representative of a person. A pop-up window allows a wide variety of ways to obtain further information about Gina or to otherwise contact Gina or to learn information such as Gina's location 531. Here also other contextual information can be presented, such as a media item involving Gina and the viewer, as well as contextual information about that ye item itself.

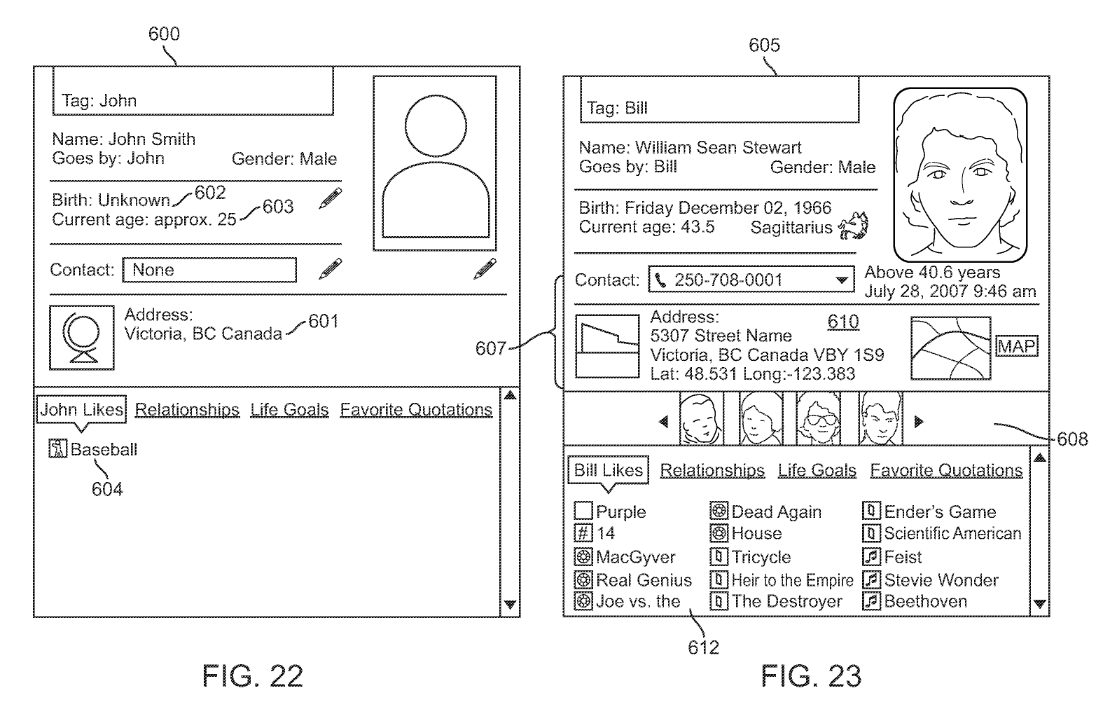

FIGS. 22 and 23 depicts other aspects of tagging relating to people. Tag 600 in FIG. 22 depicts a tag that may be created by a person who does not know the subject of the tag very well. For example, the tag may be labeled John and the folding John Smith may be known, however an exact birthday 602 may be unknown a current age may be approximated 603, a home address also may only be generally known 601. Similarly, connectivity, in which the creator of the tag and the subject of the tag engages in baseball 604 may be listed, however this may be the only connection between the tag's creator and subject of the tag. As such this tag may exist only in the local application instance of the tag Creator and can be used to tag media items in which John the subject of the tag appears.

By contrast, a more complete tag data structure can include precise workdays, full names, and complete addresses 610; map data can be sourced based on the address from API is available on the Internet, for example. A bar 608 can be presented that shows a sequence of images taken at different points during the life of Bill, which represents a progression of changes in characteristics. Such information also can be accessed directly from the user interface as depicted in FIG. 4. As would be expected, a tag created by Bill, for himself, would include a much larger conception of activities, likes, and dislikes 612. Such tag would be created within Bill's own application instance and can be shared with the server, and with the creator of tag 600, if Bill so desires. In such a situation, information from tag 605 can be propagated to the local application instance where tag 600 currently resides.

### Groups/Companies as Tags

A group is a particular type of tag that has attributes and linkage to other tags that describe the group, its members, organizational structure, goals, activities, purpose, locations and other relevant information. A group could be a company or a non-commercial organization. Among the members, the organizational structure can be defined as relationships between the members and the group as well as between the members. For example, there 50 members might be employees who directly report to the Chief Marketing Officer who in turn reports to the CEO, who reports to the Board of Directors. Each of these people would be tags with a relationship to their boss and subordinates as well as a relationship to the company.

The members of each group can be people as well as groups themselves. For example, a group might exist for a multinational which has direct employees as well as affiliates in various countries which also have affiliates for regions, each with their own members. A group can have locations for its headquarters, satellite locations, locations of affiliated groups, places it aspires to setting up new affiliates, etc. A group can have contact information including a web site, social network pages, phone numbers, email, etc. A group can have its goals and activities as tags linked to it.

A group can have links to one or more e-stores, each offering links for e-commerce items. For example, a ski hill might offer lift tickets, season passes, lodge rentals, gift certificates, ski gear, and travel packages as related information and/or actionable ecommerce items.

### Places

A place is a particular type of tag that has attributes and linkage to other tags that describe the location, including, people, groups, activities that relate to that location. Other places that relate conceptually and/or geographically can also be linked to the place. For example, a ski hill might have links to nearby towns to visit and nearby ski hills, hot springs and other nearby places. It could also have links to places that are not nearby by strongly related conceptually. For example, the Louvre in Paris, the British Museum in London and Museum of Alexandria are not geographically close, but are the main places to see archaeology from certain parts of history. People and groups can be linked to a place. For example, a place could have links to tags for people in the user's social network who have some connection to the place, either because they like visiting the place, they live there or work there or have expressed aspirational interest in going there. A place might have links to companies or groups offering services at that location, particularly services of interest to the user. For example, if going to Fisherman's Wharf, the application can highlight links to a sushi restaurant, a pool hall and a dancing bar if these activities matched up with a user's interests. There can also be contact information and links to informational websites regarding a location. For example, there might be contact information and web pages that describe a hiking area even though there are no businesses or groups physically located there.

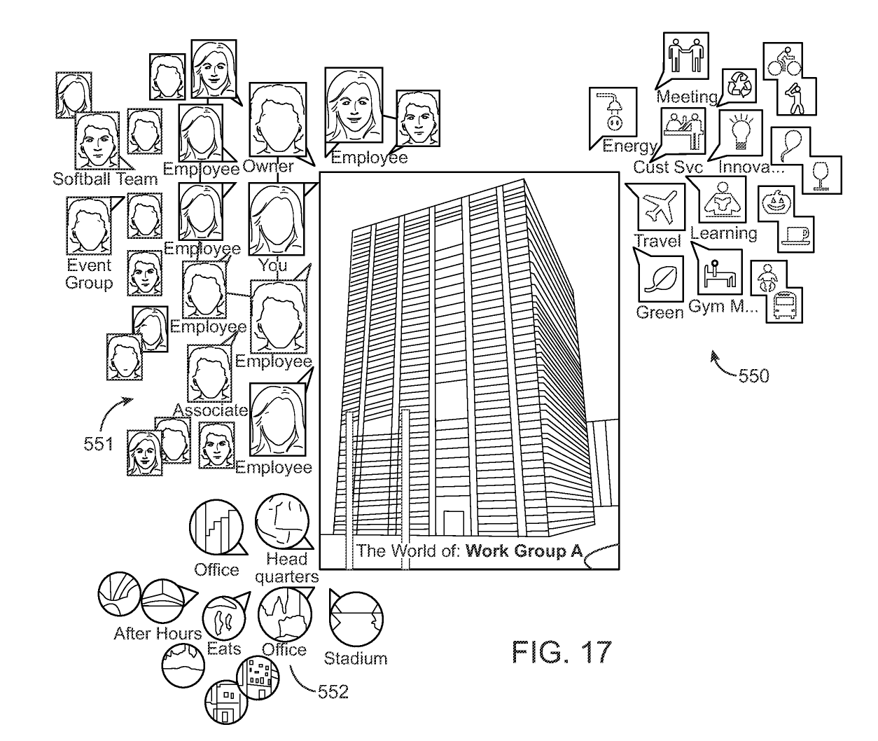

FIG. 17 depicts an example where a work location is in focus. Similarly to display of persons or media items selection of a work location causes a rearrangement of the depicted tags or a re-selection from among available tags to emphasize persons locations and activities relevant to the focus of workgroup A. As shown generally by a rearrangement 551 of persons where employees are located close to the item in focus, while groups such as the softball team is located somewhat more peripherally. Here differentials in size of tags presented or other differentiating means disclosed above can indicate a relative importance of the persons locations or activities to the world of workgroup A. Reference 550 generally indicates the activities selected for depiction, while 552 identifies locations.

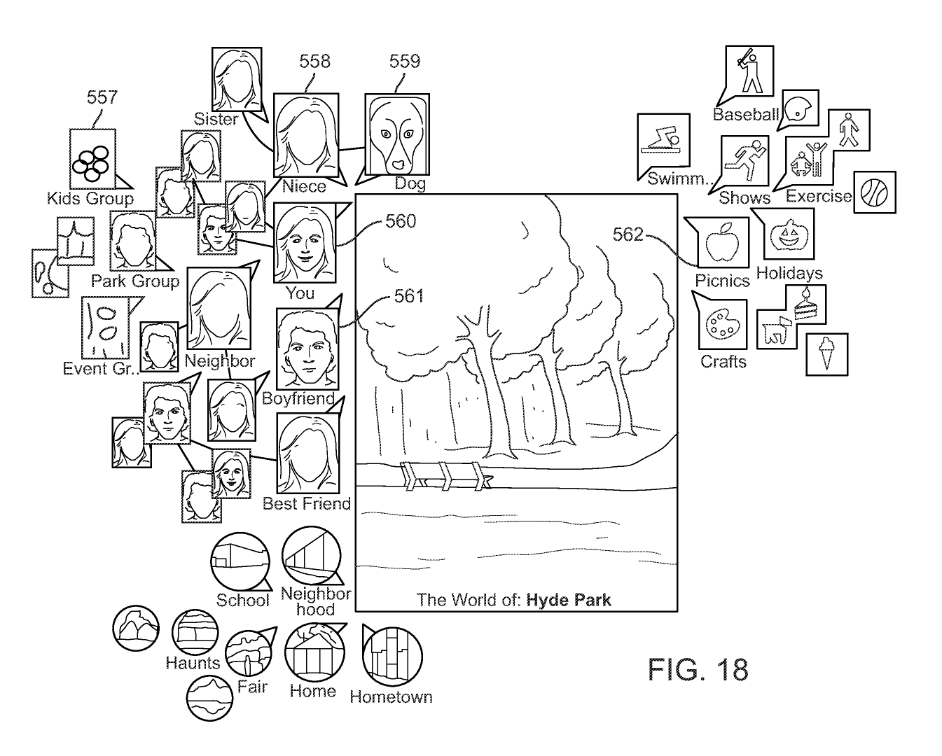

Analogous example is shown with respect to FIG. 18, which shows that the world of Hyde Park from the perspective of the viewer labeled you 560. As may be expected a boyfriend 561 features prominently in this world of a park. Similarly, a Nice 558 and a dog 559 also are displayed close to and comparatively larger than other tags representative of persons. As for such comparative importance can be determined based on a number of pictures tagged relating to both Hyde Park and boyfriend for example. Other person information can be depicted such as an icon for a kids group 557. Here also, the kids group icon may be depicted in response to detection of correlation between pictures involving parks or more particularly this park and persons or even the entirety of the group. As would be expected with respect to activities a common activity to occur in a park would be picnics 562, which indicates again the detection of correlation based on tagging data.

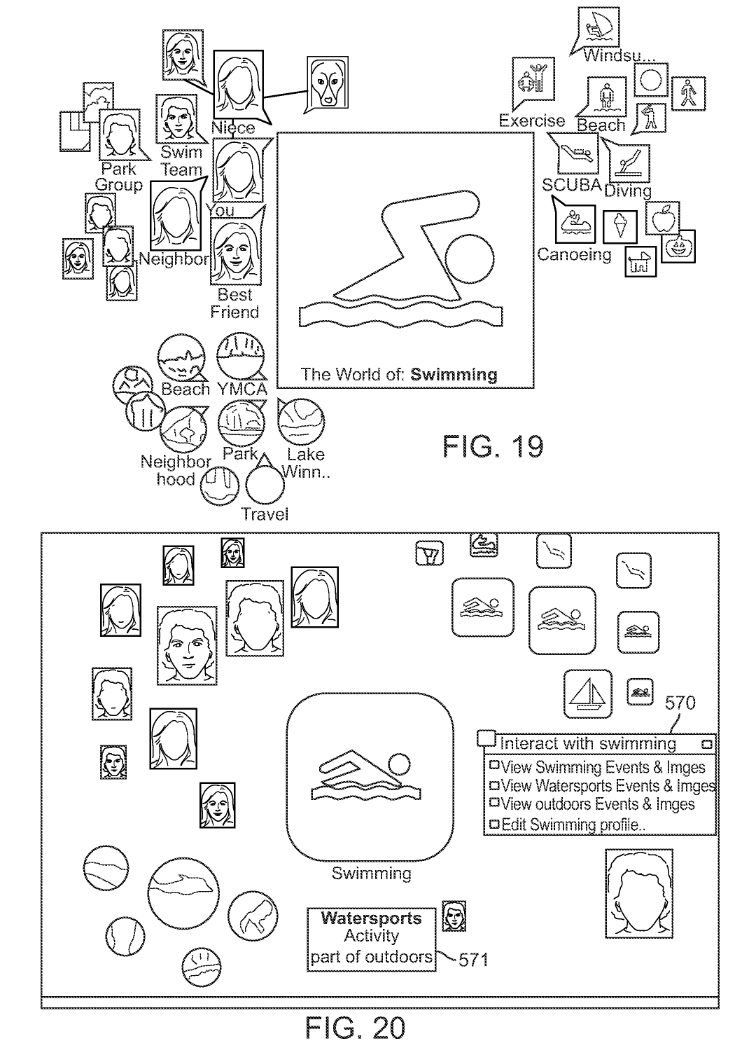

FIGS. 19 and 20 depict examples where an activity is a central focus. The disclosure above applies to FIGS. 19 and 20 and only particular. Further disclosures relevant to these Figures is described below. With respect to an activity some further fields are other information that can be found in tag data structures for such activities can include or otherwise reference sources of information about events and images available from a network or the Internet, or information about tag categories higher or lower in a taxonomy of tags in which swimming fits. Such concepts are represented in window 570, where descriptive information can be presented underneath the swimming icon, which shows how the activity swimming fits into a hierarchical taxonomy of tags relating to concepts 571.

### Activities/Subject Matter

An activity is a particular type of tag that has attributes and linkage to other tags that describe an activity or subject matter, including, people, groups, places and other activities that relate to that activity. The people and groups who are related to an activity can be linked to that activity. For example, within a local album, the people who are known to be interested in an activity would be linked to the activity. On a global scale, there could be links to the originator(s) of an activity, the best practitioners and organizations that can help the user pursue that activity. For example, Astronomy could link to your local friends who also have an interest in astronomy, but it can also link to Galileo as the historical originator as well as groups that promote Astronomy locally or on a global level. This would allow someone interested in an Activity to organize events with people they know are interested, to learn more about their field of interest and to pursue their interest through education, outings, etc. Activities are organized within a hierarchical taxonomy so that related activities are siblings, each parented from a root activity and each capable of having any number of child activities for more specificity.

For example, Optical Astronomy and Radio Astronomy would both be children of Astronomy, possibly in a taxonomy as such, where the top of the hierarchy is “Learning”, followed by more specific categories, as follows: Learning: Inorganic Science: Astronomy: Radio Astronomy. Such a taxonomy allows users interested in one narrow activity to have related activities surfaced to them in a way that allows them to stretch their interests if they so choose.

Activities can also link to places relevant to that activity. The linked places could be close to the user's home, close to their current location or highly relevant conceptually even if not close to the user. For example, “skiing” as an activity might link to the best locations in the world to, the places the user has actually been known to go skiing, places they wish to go skiing, or ski places they are physically close to at the current moment.

What can you do with the Tagging

If a user expresses a deeper interest in a rich media item, the minicloud promotes to a more immersive cloud of information and user interface to interact with the photo or related items. In this example, the lower left shows where the picture was taken and distance to the viewer, the upper left shows who is in the picture and ages at time of picture, the upper right shows subject matter or activities related to the rich media (in this case sculpture at a beach). Hovering over any of the graphical icons gives more detail about people, places, activities, groups).

### Point of View Tag Display

Everything shown in a cloud is expressed and selected in a Subjective manner, relative to the particular viewer. For example, if a girl views a picture with her father, he might be labeled “Dad” instead of Bill and her grandmother might be labeled “Grandma Stewart” instead of Vickie. Also, the choice of the most relevant people, places and activities is not just with respect to the rich media or tag at the center of a cloud, but also with respect to likely interest to the subjective viewer who has a certain point of view.

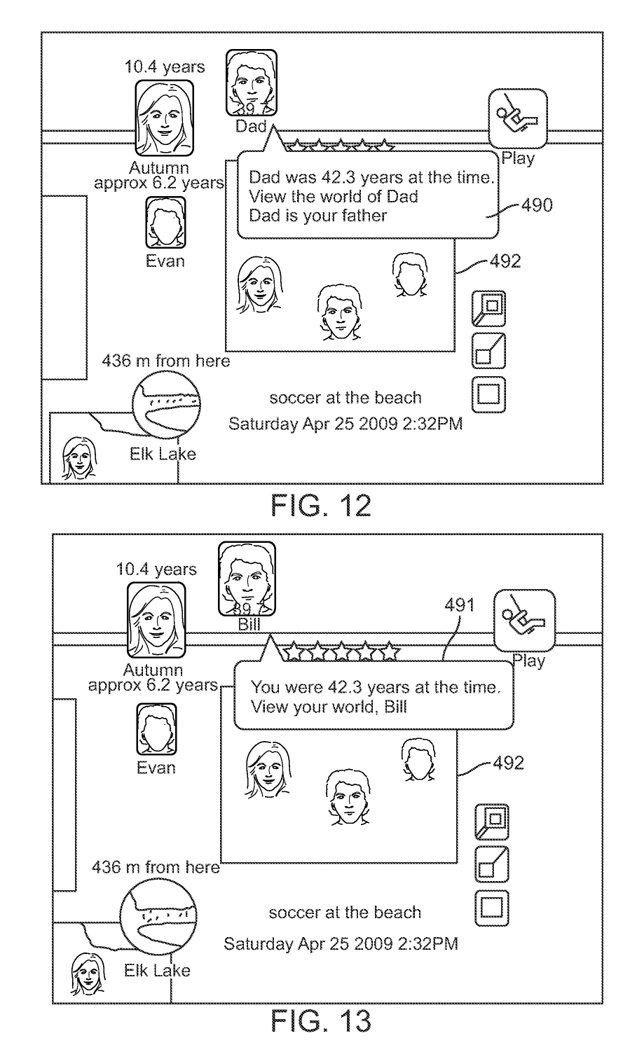

For example FIGS. 12 and 13 are used to depict point of view specific image context presentation. FIG. 12 depicts a user interface displaying a media item 492 where the viewer, as can be determined by a registered user of a particular application instance, is a child of a person whose tag is displayed and who is present in the media item in focus 492. Contextual information specific to the viewpoint of the present viewer 490 can be shown. For example, a difference term can be used to describe the same person, in particular dad versus Bill when comparing FIG. 12 to FIG. 13. Further, different persons, different locations and different activity icons can also be displayed which would be selected based on a relationship between the local taxonomy of tags presence in the child's application instance compared with the taxonomy of tags presence in the fathers application instance. To complete the example FIG. 13 shows that when the father whose name is Bill use the same picture 492 context or other information about the photo is phrased differently.

The data used to populate each of these contextual messages 490 and 491 can come from a tag for Bill and from local application instances for each of Bill and the child which respectively define a relationship between Bill and the viewer associated with that application instance.

A person can tag a piece of rich media in a far more sophisticated way than what is possible now. For instance, a person (John) who tags a photo of his mom as “mother” and his daughter as “Susie” will automatically see “This is your mother” when viewing the mother's picture or “this is your daughter, Susie,” while viewing the daughter's picture. His own picture might be tagged “me.”

Context awareness is evident when others view the same tagged photos. When Susie logs on and has done no such tagging—manually or automatically—her photos would surface not the original “mother” tag but now as “grandmother.” And it will note the original tagger as “dad.” This is without any tagging on Susie's part.

Creating Tags from Photos

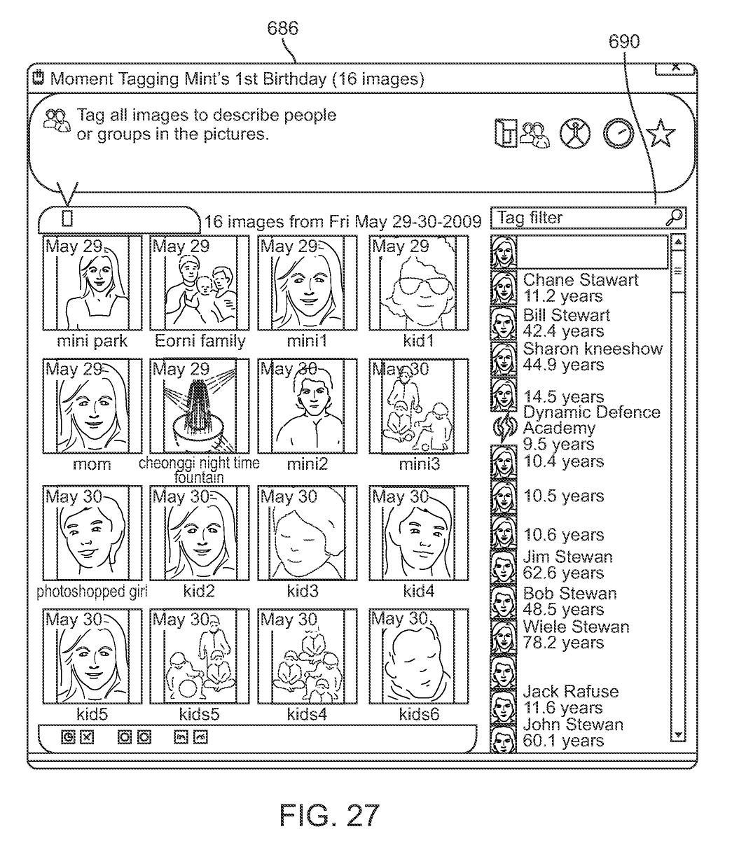

Certain aspects are related to allowing tags to be created from photos as well as Association of tags with photos or other media items. FIG. 27 depicts an example of user interface 686 where a number of pictures are ready to be imported. A tag filter 690 can be presented in which a user can search for a particular tag. A number of pictures can be selected to be highlighted such as by applying control with mouse clicks or shift with mouse clicks and then one or more tags can be selected from the bar 690. Thereafter those tags will be associated with those images, such that when viewing those images that data relating to those tags can be used in determining persons activities and locations to be displayed around the periphery of such media items. Still further such associations of tags and media items can be used to select collages of media items to be shared. As described above.

When photos are imported from a camera, a contact sheet showing all the photos at once is displayed. If a person in a photo is not already in your social network list, the user can click the ‘Add Tagged Person’ button (or ‘Add Tagged Place’ if looking at locations instead of people) to add the person in the photo as a new tag. The user is then prompted to crop the photo to just the face of the person they wish to add, or they may press ‘Enter’ to use the whole photo if it's a head shot of the person and no cropping is required. After cropping, the New tag dialog allows them to set a name and other optional attributes such as birth date, etc before saving the new person in the tag list for their album. The same process applies to adding new locations except that when places are added, the tag images are assumed to be roughly square whereas tag images of people are usually somewhat tall and narrow head shots.

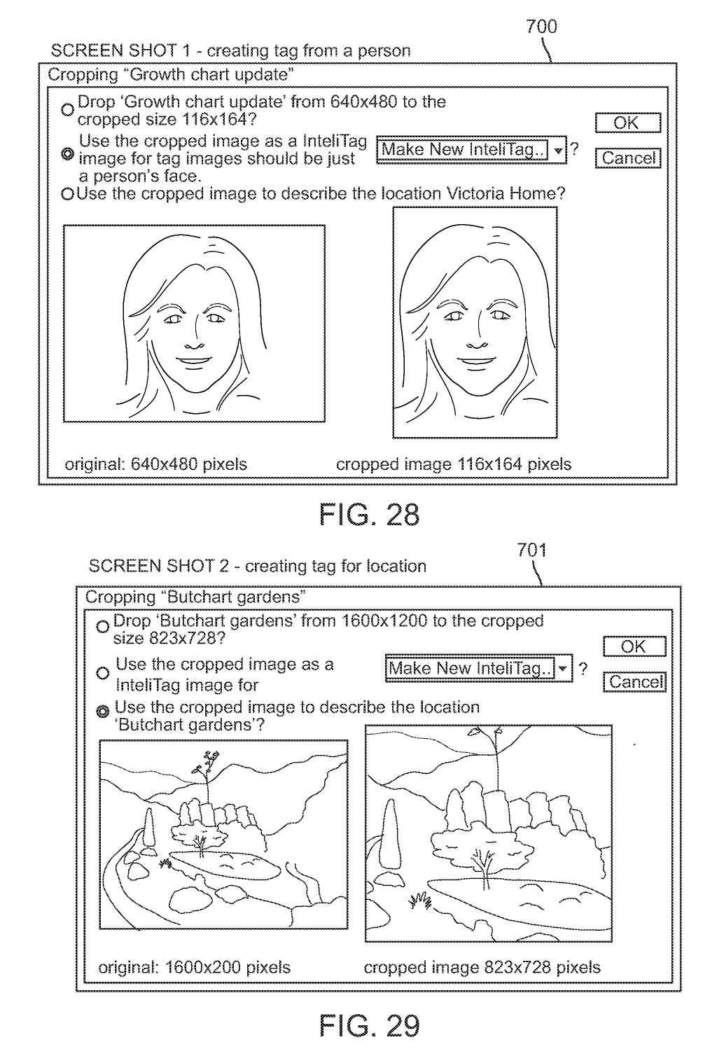

FIG. 28 depicts an example where a new tag can be associated with an image. A user interface 700 allows a user to easily crop a larger, higher resolution image into a smaller lower resolution image. FIG. 29 similarly illustrates creation of a lower resolution image that can be used as a tag for a place to chart gardens. Based on a higher resolution image. The higher resolution image can remain available to be viewed such as by clicking on a lower resolution image displayed when a yet further image is in focus.

When viewing a picture either on the desktop wallpaper or in an image editor, use a pointing device to select a box around a face to create a new tag on the fly. The selection is transformed into an avatar representing the person, place, group or thing. For a person, the user would normally select the area around a person's face. This act in itself will lead the application to prompt the user to create a new tag based on that image.

However, they can also use this photo selection mechanism to add additional tag images to an existing tag. For a person, one might collect tag images of their face over the years, thus creating a series of head shots that show how they have changed and aged over time. With a physical location, multiple tag images can show different aspects of a place, how it the exterior differs from the interior, how it has changed over time or what it looks like in different seasons.

### Creating new Subject Matter/Activity Tags

When tagging, there is a visual list of all global tags plus any local tags the user has added themselves. When they need to tag something more specifically, they can create new tags. Users can type free form tags. When doing so, the application autocompletes and has an autosuggest dropdown list of possible matches from existing Tagsonomy. If user insists on new tag as typed, they are presented with a way to place that new tag into the Tagsonomy so it has meaning. Without placing tags into a Tagsonomy, the application would not be able to infer meaning, as tags would just be a string of characters, without a relationship to an existing ontology or taxonomy.

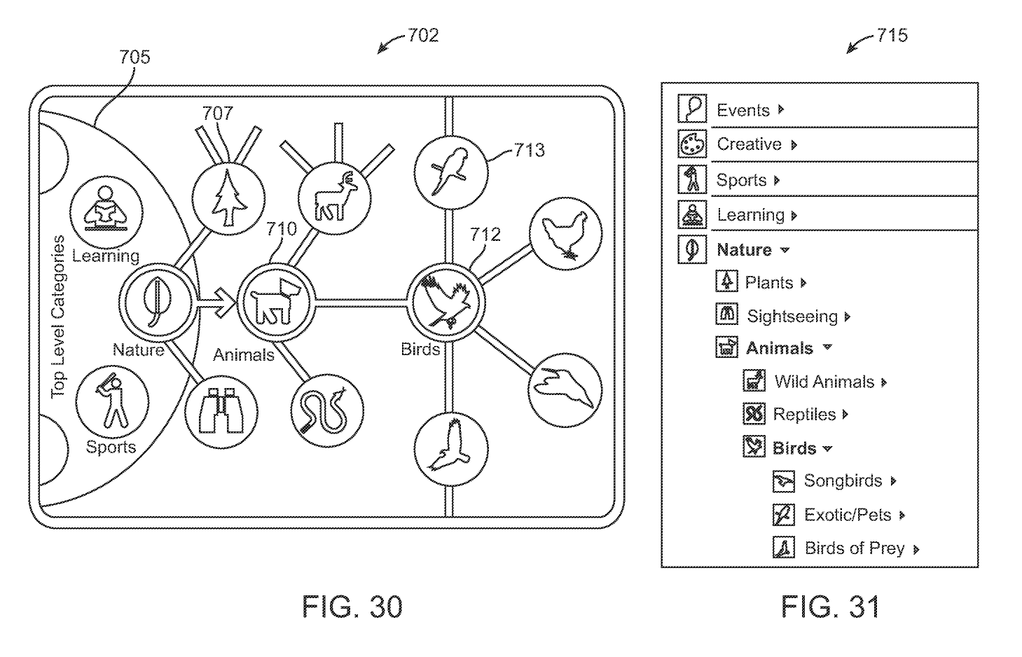

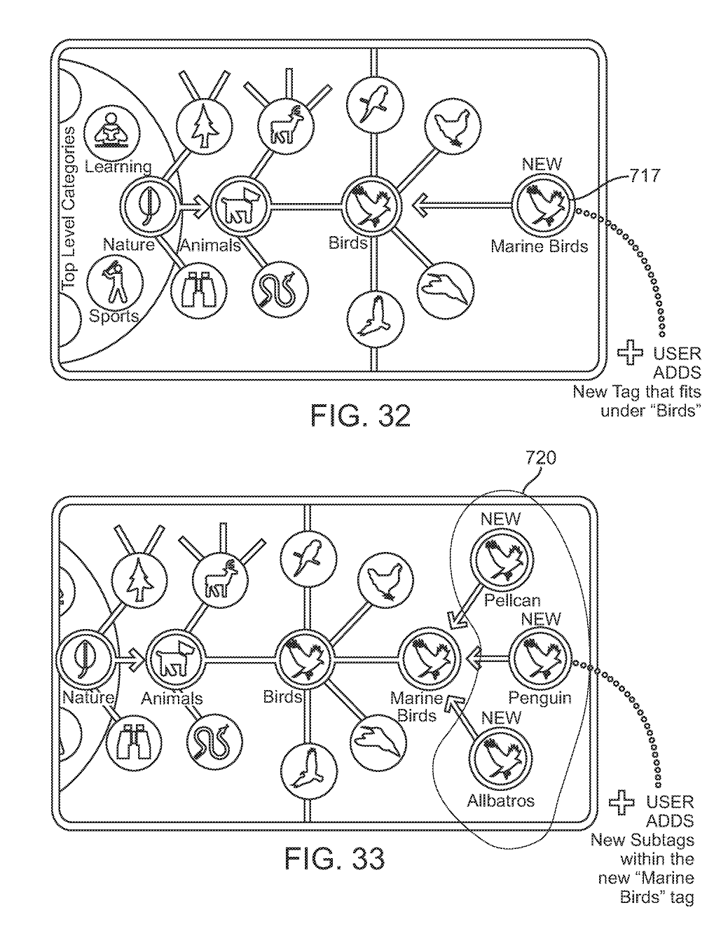

A variety of description was presented above about the existence of a categorization or hierarchy of tags relating to concepts such as activities and locations. FIG. 30 and FIG. 31 depicts a graphical and list oriented view into such categorization or hierarchy. For example, top level categories for activity 705 can include tags for learning, nature, and sports. The tag for nature can include children to head's such as tag 707 and 710. Still further, tag 710 can include further child tag 712 which relates to birds which are animals found in nature. As can be observed by viewing the list oriented displayed in FIG. 31. Similar information is found, such depictions can be used as user interfaces for allowing selection of tags to associated with a particular media item or media items.

Still further, such depiction can be used in extending or modifying such a taxonomy of tags. For example, a new tag for marine birds 717 can be added by a user to his local tag hierarchy subcategories of marine birds also can be added by that user to his local application instance such as pelican penguin and allbatros collectively identified 720. Regardless of the merits of any such tags added to a user's local tag hierarchy those tags will be added and otherwise available to be used within that local application instance. Such local tag hierarchy also can be mirrored to server 87, even though it is not effective to modify a reference or canonical tag hierarchy.

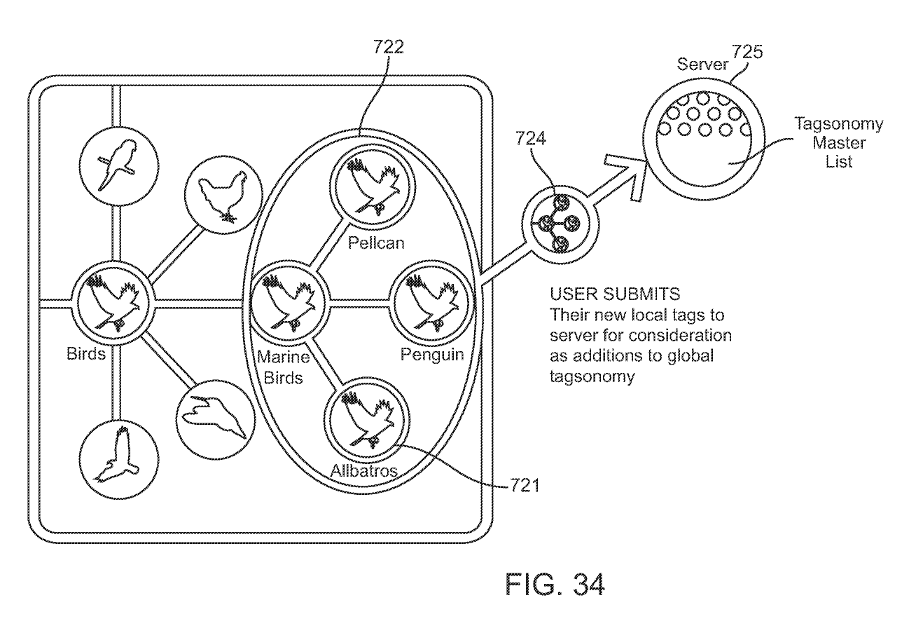

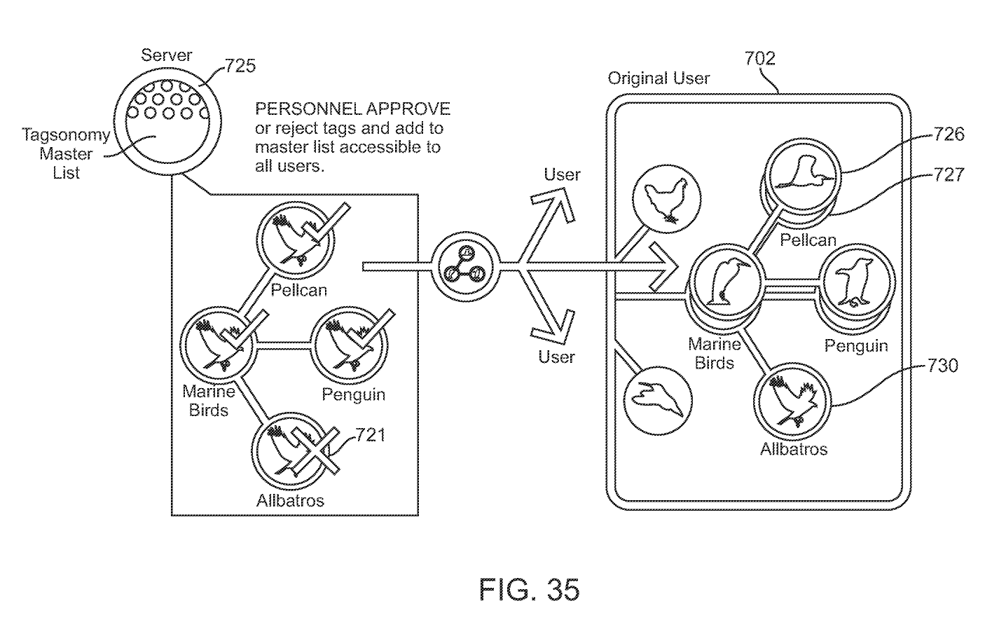

However, the system can provide a user focused ability to extend the canonical tag hierarchy by offering tags added to users local application instances for inclusion into a master tag hierarchy. FIG. 34 depicts operations involved in such addition. In particular, the group of new tags collectively identified as 722 is submitted in a message 724 to server 725. FIG. 35 depicts that app server 725 personnel can review the submitted tags and decide whether to extend the canonical tag hierarchy has suggested. Since marine birds penguin and pelican all are acceptable additions and logically fit under the category marine birds which already exists in the master tag hierarchy. They are accepted for addition. However, the tag for allbatros 721 is rejected, based on a misspelling of the word Albatross. FIG. 35 further depicts that the updated master taxonomy can be synchronized to local application instances as shown by the original users tag structure 702, now having supplements for pelican marine birds and penguin. FIG. 35 depicts that such tags can be considered duplicates 726 and 727, and in other implementations upon synchronization. The original user's tag can be replaced by a tag maintained in the master tag hierarchy.

### Sharing Outside of Social Network

These aspects of context-aware tagging can work outside of a person's social network, as it exists at any given time. When people are tagged at the same location and activity or even perhaps even the same location and time, the application can find and surface connections between people and experiences. If privacy rules allow, this can occur among people with some sort of relationship or even strangers. For example, if you climb a rock face and are open to meeting other climbers who like that location, you could mark your rich media as public in which case other climbers who go to the same place can be linked in from your photos at that cliff and their photos could link to you or your photos. People could learn things from other people's experiences (which routes are best to climb) but could also connect with people they would like to communicate with or meet in person since there is a shared interest at a common location.

When people express an interest in a location as somewhere they're considering moving or traveling to visit, relevant people, places, activities and experiences can be surfaced dependent on privacy settings and relevance. For example, if moving to New York, it might be useful for the application to surface friends who live there, restaurants likely to match your taste and also surface popular activities to partake in that location, thereby helping plan a move or visit to that location.

If you see a friend, family member or celebrity in a photo, you can tag them in that photo even if they are not a member of the network already. This is completely different from current tagging systems. With other tagging systems, either a) simple text is used to tag images with no linkage to real people or groups or b) users are limited to select from people who have already created their own account so they exist globally on a social network and have a friend relationship with the user.

In contrast, tag data structures representing people, groups, activities and places can be created on the fly, with links to real things in the world. For example, 50 people might occasionally do archery with John and tag him in their archery pictures even though he hasn't joined the service (or have the application) and created his own profile yet. Some might be friends with John and have added a few more details about him whereas others might only know him as a 30-ish man who does archery and have only that detail in their tag for him. If John then joined and created a richly detailed profile for himself, he could allow all 50 of those archery friends to link to his detailed profile. This would then mean that if any of those 50 people looked at an archery picture with John in it, they would be one click away from communicating with him or any details he cares to make public about himself (such as his favorite music, books, things to do, places to go and other preferences) which he could edit and change over time.

### Intuitive Group Creation

The contact groups make sharing much safer and quicker, while the creation of groups is also something that the application can automate or facilitate, in addition to bootstrapping relationship mapping based on simple sharing actions. Behavioural cues can be used to derive hypothetical rules which can automate part of the sharing process. For example, if a new user tags photos with their infant child and goes to share them, they will not have any groups of users established already. When they manually choose people to share the content with, the application then asks if they wish to add those contacts to a new group, “Close Friends and Family”.

Doing so also implies that the contacts should be reasonably close on the relationship map, so the user would be prompted to allow them to be mapped into the circle of trust and shown the result. They would be able to drag and drop to move contacts closer or further away and would also have the option of defining their actual relationship with the close friends and family that just popped into their inner circle.

In this way, the simple act of manually sharing various types of content with various contacts bootstraps a series of groups and the customization of the relationship map. After manually selecting users to share various groups of content, the user will end up with a series of very useful contact groups and relationships defined for many of the people important to them.

This information clearly streamlines any further sharing since the user will have less and less need to manually select individuals to share with, since the AI Sharing Agent will allow quicker and safer access to the contact groups they've already established, while always allowing individuals to be added or removed for sharing at any time.

### Artificial Intelligent (AI) Sharing Assistant

The application can use heuristics to help user resolve duplicate contacts from various systems to provide a unified view. All contacts also are mapped into a relationship taxonomy. Pre-established relationships on other networks may be imported for some contacts, but in all cases, the application allows flexible mapping of relationships from the user to contacts and between various contacts. The relationship map allows users to easily control how much of their life to share with various contacts and not with others. This is in contrast to most social networks which currently have one level of connection as the default, either friend (meaning everything is shared) or not a friend (meaning nothing can be shared or tagged with that individual). The application relationship map can have subtler gradations of connection, which better reflect the subtleties of real world relationships.

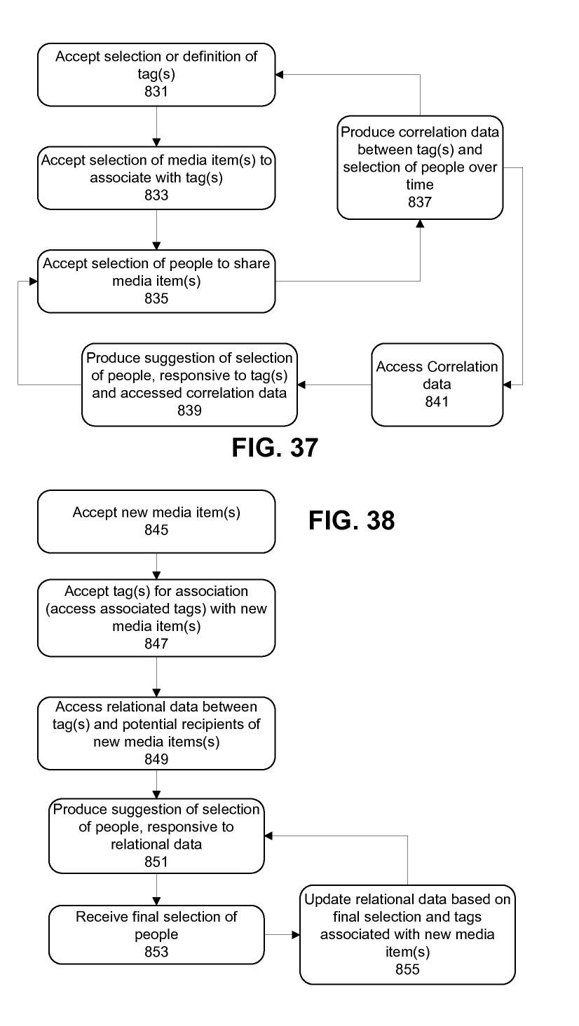

FIG. 37 depicts an example of media item intake, which can rely on intelligence provided in the sharing assistant as well as systems organized according to the examples of FIGS. 25 and 26. The depicted method includes acceptance (831) of a selection or definition of tags, such as a selection and or definition of tags displayed in the user interface example of FIG. 27. A selection of media items to be associated with those tag or tags can also be accepted (833). Initially, a user may be presented with the capability to select a person or persons to share these media items with (835). The application can track which people (represented by tags associated with them) have been associated with media items that are also associated with other tags. The application can produce correlation data between these tags and the people selected (837). This correlation data can be used to suggest other tags for particular media items, as well as to suggest a selection of people responsive to an indication of tags to be associated with media items as depicted in the steps of accessing correlation data (841) and producing suggestions of selections of people, responsive to tags and the accessed correlation data (839).

FIG. 38 depicts an approach to accepting new media items and providing an easier mechanism to in bed those media items within context already in place in a given application. The method depicted includes accepting a new media item (845) one or more tags can be accepted for association with these new media items (847). Using relational data between the tags excepted, such as other media items that have been tagged with those tags, as well as other concepts or entities that are related to these tags via one or more intermediate tags, a suggested selection of people can be produced (851) with which to share these new media items. A user of the application can modify that suggested selection, thereby achieving a final selection of people which is received by the application (853). The relational data access at (849) is updated responsive to modifications made by the user in 853. Thus, a next time the method depicted in FIG. 38 is invoked. This updated relational data will be used to produce a suggestion of people with which to share new media items.

Updating of relational data (855) can be implemented by a suggestion of creation of new groups, modification of membership in existing groups, as well as changes to the trust model depicted in FIG. 25.

What is claimed is:

1. A system, comprising:
a client application interfacing with a local library of media items and operable to accept tags to associate with the media items, and to maintain the accepted tags in a local hierarchical based on inputs received through an interface;
a reference tag database, comprising a canonical set of tags organized into a reference hierarchy; and
wherein the client application is operable to accept tags from the canonical set and present those tags, with tags locally entered through the interface as potential tags for media items being added to the local media library, and to accept inputs through the interface for tags to associate with the media items added to the local media library, and wherein the locally entered tags and any tags from the reference tag database are maintained separately.

2. The system of claim 1, wherein each tag is represented by a data structure comprising one or more fields for text labels, and one or more fields to identify other tag data structures to which the tag relates.

3. The system of claim 2, wherein the one or more fields to identify other tag data structures to which the tag relates each further comprise a sub-field for identifying a relationship between the identified tag and the tag in which those fields are comprised.

4. A method, comprising:
receiving, from a plurality of remote computer resources, sets of visual content items, and metadata associated with the content items; and
identifying a common characteristic of at least one visual content item in multiple of the sets, and based on the common characteristic, identifying a plurality of elements of metadata associated with the common characteristic, determining whether any of the identified elements of metadata describe a concept more generically than another of the identified elements of metadata, and responsively
proposing to replace the generic metadata element with the specific metadata element in association with one or more of the visual content items having the common characteristic.

5. The method of claim 4, wherein each of the sets of visual content items and the metadata is associated with a respective source.

6. The method of claim 4, further comprising establishing a connection between each source visual content items having the common characteristic.

7. The method of claim 4, wherein establishment of the connection provides for sharing of previously-private information associated with the visual content items having the common characteristic.

8. A system, comprising:
a server for storing canonical tags, each relating to a subject, selected from a person, a place, a thing, or a period in time;
an application, which can be instantiated into local application instances, each operable to maintain a local repository of items and metadata associated with the items, and to accept input indicating which items of the local repository are to be made available at the server, wherein
the server is further for receiving the items made available to it and the metadata associated with those items, and for identifying one or more canonical tags that may refer to a common concept with one or more portions of the metadata associated with the items, and for signaling to the local application instance an opportunity to replace the portions of the metadata with the canonical tags.

9. A computer readable medium comprising instructions for programming a computer to perform a method, comprising:
accessing a computer readable medium to retrieve a media item from a library;
displaying the media item; and
displaying a user interface comprising an interface for displaying a hierarchy of tags used to label at least one media item in the library, for accepting text to be used as a new tag for the media item, and for accepting an indication of relationship between the new tag and one or more tags of the hierarchy.

10. A method, comprising:
creating a first local application instance, with a respective local store of media items and a locally-scoped store of tags, each tag associated with one or more of the media items and comprising text for display and one or more relational attributes, each establishing a linkage to another tag;
identifying a media item for consumption by a consumer;
determining a relationship between the consumer of the media item and the media item, using one or more relational attributes associated with one or more tags that are associated with the identified media item; and
and selecting text that describes a relationship between the consumer of the media item and the media item, using at least one relational attribute comprised in a tag stored in the locally-scoped store of tags.

11. The method of claim 10, further comprising accepting, at the first local application instance, a new tag definition comprising text for display, and one or more relational attributes.

12. The method of claim 10, further comprising initially populating the locally-scoped store of tags from a canonical store of tags at a server. The method of claim 12, further comprising updating the canonical store of tags with changes made to the locally-scoped store of tags.
